(19) United States
(12) Patent Application Publication
(10) Pub. No.: US 2024/0411237 A1
(43) Pub. Date: Dec. 12, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Tomoya Sasaki, Kanagawa (JP); Ryosuke FUJII, Kanagawa (JP); Hiroko Kobayashi, Kanagawa (JP); Yuto Okazaki, Kanagawa (JP); Masahiro Iwasaki, Kanagawa (JP); Yuki Oyamada, Kanagawa (JP); Kosuke Narita, Kanagawa (JP)

(73) Assignee: FUJIFILM Business Innovation Corp., Tokyo (JP)

(21) Appl. No.: 18/434,864

(22) Filed: Feb. 7, 2024

(30) Foreign Application Priority Data
Jun. 9, 2023 (JP) 2023-095870

(51) Int. Cl. G03G 5/14; G03G 5/07; G03G 21/18

(52) U.S. Cl. CPC G03G 5/142; G03G 5/075; G03G 21/1814

(57) ABSTRACT

An electrophotographic photoreceptor includes a conductive substrate, an undercoat layer disposed on the conductive substrate, and a photosensitive layer disposed on the undercoat layer, in which the undercoat layer contains a binder resin and at least one perinone compound selected from the group consisting of a compound represented by Formula (1) and a compound represented by Formula (2), the photosensitive layer contains a polyester resin (1) having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B), and a mass proportion of the polyester resin (1) in the photosensitive layer is 15% by mass or greater,

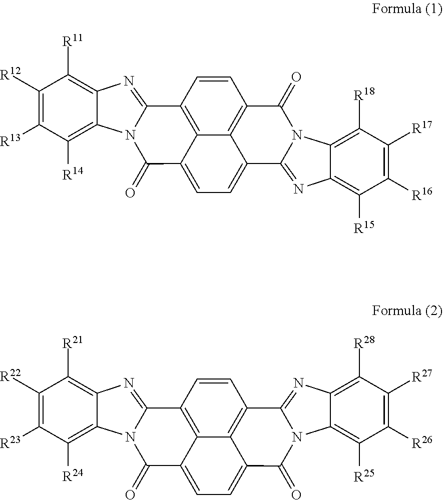

in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, and R¹³ and R¹⁴ may be each independently linked to each other to form a ring, and R¹⁵ and R¹⁶, R¹⁶ and R¹⁷, and R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, and R²³ and R²⁴ may be each independently linked to each other to form a ring, and R²⁵ and R²⁶, R²⁶ and R²⁷, and R²⁷ and R²⁸ may be each independently linked to each other to form a ring,

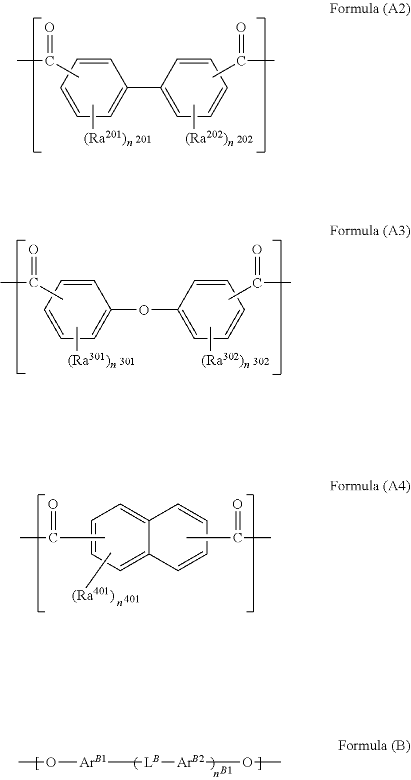

in Formula (A2), n²⁰¹ and n²⁰² each independently represent an integer of 0 or greater and 4 or less, and n²⁰¹ pieces of Ra²⁰¹'s and n²⁰² pieces of Ra²⁰²'s each independently represent an alkyl group having 1 or more and 10 or less carbon atoms, an aryl group having 6 or more and 12 or less carbon atoms, or an alkoxy group having 1 or more and 6 or less carbon atoms,
in Formula (A3), n³⁰¹ and n³⁰² each independently represent an integer of 0 or greater and 4 or less, and n³⁰¹ pieces of Ra³⁰¹'s and n³⁰² pieces of Ra³⁰²'s each independently represent an alkyl group having 1 or more and 10 or less carbon atoms, an aryl group having 6 or more and 12 or less carbon atoms, or an alkoxy group having 1 or more and 6 or less carbon atoms,
in Formula (A4), n⁴⁰¹ represents an integer of 0 or greater and 6 or less, and n⁴⁰¹ pieces of Ra⁴⁰¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2. Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

### CROSS-REFERENCE TO RELATED APPLICATIONS

This application is based on and claims priority under 35 USC 119 from Japanese Patent Application No. 2023-095870 filed Jun. 9, 2023.

### BACKGROUND

### (i) Technical Field

The present invention relates to an electrophotographic photoreceptor, a process cartridge, and an image forming apparatus.

### (ii) Related Art

JP2020-046640A discloses an electrophotographic photoreceptor that includes a conductive substrate, an undercoat layer, and a photosensitive layer, in which the undercoat layer contains a perinone compound and polyurethane.

JP2020-046641A discloses an electrophotographic photoreceptor that includes a conductive substrate, an undercoat layer, and a photosensitive layer, in which the undercoat layer contains a perinone compound and an acceptor compound.

JP2020-101652A discloses an electrophotographic photoreceptor that includes a conductive substrate, an undercoat layer, and a photosensitive layer, in which the undercoat layer contains a perinone compound, an amine compound having an ionization potential of 5.4 eV or greater and 5.9 eV or less, and a binder resin.

JP2004-354697A discloses an electrophotographic photoreceptor that includes an interlayer containing N-type semiconductive particles on a conductive support, and a photosensitive layer containing a P-type pigment and an N-type pigment.

JP2011-095665A discloses an electrophotographic photoreceptor including an interlayer and a photosensitive layer which are provided on a conductive support, in which the interlayer contains a polyolefin resin and an organic electron transport material, and the organic electron transport material is a compound selected from the group consisting of an imide-based compound, a benzimidazole-based compound, a quinone-based compound, a cyclopentadienylidene-based compound, an azo-based compound, and derivatives thereof.

JP2021-015223A discloses an electrophotographic photoreceptor in which an undercoat layer and a photosensitive layer are laminated on a conductive support, and at least one of the undercoat layer or the photosensitive layer contains a compound represented by Formula A (compound in which a benzimidazole ring is introduced to one side of a naphthalenetetracarboxylic acid diimide skeleton).

### SUMMARY

Aspects of non-limiting embodiments of the present disclosure relate to an electrophotographic photoreceptor in which a difference in electrical properties between an initial stage and a final stage of repeated image formation is small, burn-in ghosts are unlikely to occur in an image, and these effects are realized over a relatively wide region where charging intensity and exposure intensity are set, as compared with a case where a mass proportion of a polyester resin (1) in a photosensitive layer is less than 15% by mass.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspects. Each formula is the same as the formula having the same number described below.

According to an aspect of the present disclosure, there is provided an electrophotographic photoreceptor including: a conductive substrate; an undercoat layer disposed on the conductive substrate; and a photosensitive layer disposed on the undercoat layer, in which the undercoat layer contains a binder resin and at least one perinone compound selected from the group consisting of a compound represented by Formula (1) and a compound represented by Formula (2), the photosensitive layer contains a polyester resin (1) having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B), and a mass proportion of the polyester resin (1) in the photosensitive layer is 15% by mass or greater.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a partial cross-sectional view showing another example of a layer configuration of an electrophotographic photoreceptor according to the present exemplary embodiment;

FIG. 3 is a schematic configuration view showing an example of an image forming apparatus according to the present exemplary embodiment;

FIG. 4 is a schematic configuration view showing another example of an image forming apparatus according to the present exemplary embodiment; and

FIGS. 5A to 5D are views showing evaluation standards of burn-in ghosts in Examples.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual, and a relative relation in the sizes between the members is not limited thereto.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

In the present disclosure, an alkyl group and an alkylene group are any of linear, branched, or cyclic unless otherwise specified.

In the present disclosure, a hydrogen atom in an organic group, an aromatic ring, a linking group, an alkyl group, an alkylene group, an aryl group, an aralkyl group, an alkoxy group, an aryloxy group, or the like may be substituted with a halogen atom.

In the present disclosure, in a case where a compound is represented by a structural formula, the compound may be represented by a structural formula in which symbols (C and H) representing a carbon atom and a hydrogen atom in a hydrocarbon group and/or a hydrocarbon chain are omitted.

In the present disclosure, the term “constitutional unit” of a copolymer or a resin has the same definition as that for a monomer unit.

### Electrophotographic Photoreceptor

An electrophotographic photoreceptor according to the present exemplary embodiment (hereinafter, also referred to as “photoreceptor”) includes a conductive substrate, an undercoat layer disposed on the conductive substrate, and a photosensitive layer disposed on the undercoat layer.

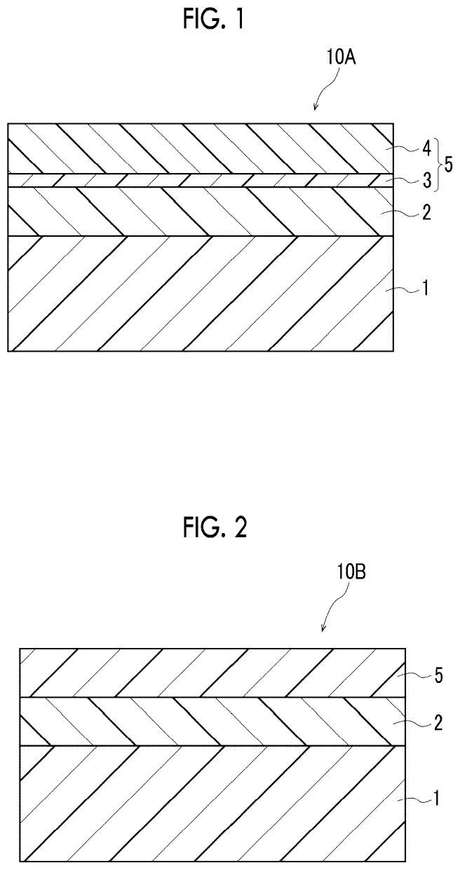

FIG. 1 is a partial cross-sectional view schematically showing an example of a layer configuration of a photoreceptor according to the present exemplary embodiment. A photoreceptor 10A shown in FIG. 1 includes a lamination type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation type photosensitive layer). The photoreceptor 10A may include an interlayer (not shown) between the undercoat layer 2 and the charge generation layer 3.

FIG. 2 is a partial cross-sectional view schematically showing another example of a layer configuration of a photoreceptor according to the present exemplary embodiment. A photoreceptor 10B shown in FIG. 2 includes a single layer type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5.

In the photoreceptor according to the present exemplary embodiment, the undercoat layer contains a binder resin and at least one perinone compound selected from the group consisting of a compound represented by Formula (1) and a compound represented by Formula (2), the photosensitive layer contains a polyester resin (1) having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B), and a mass proportion of the polyester resin (1) in the photosensitive layer is 15% by mass or greater.

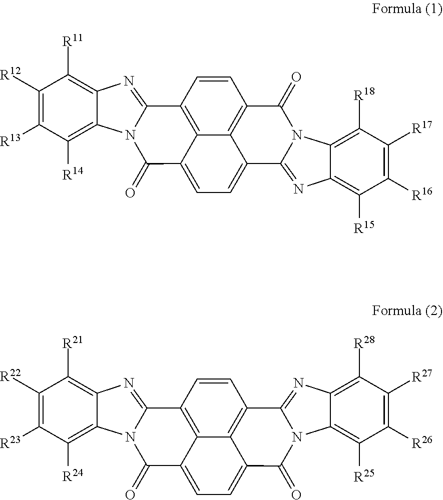

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R¹¹ and R¹², R¹² and R¹³, and R¹³ and R¹⁴ may be each independently linked to each other to form a ring. R¹⁵ and R¹⁶, R¹⁶ and R¹⁷, and R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R²¹ and R²², R²² and R²³, and R²³ and R²⁴ may be each independently linked to each other to form a ring. R²⁵ and R²⁶, R²⁶ and R²⁷, and R²⁷ and R²⁸ may be each independently linked to each other to form a ring.

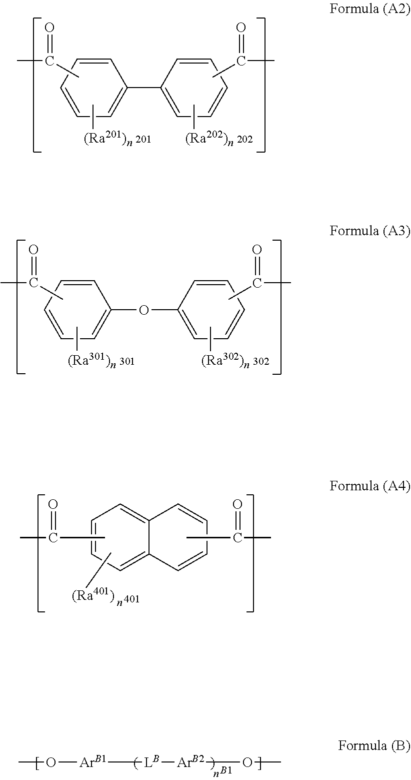

In Formula (A2), n²⁰¹ and n²⁰² each independently represent an integer of 0 or greater and 4 or less, and n²⁰¹ pieces of Ra²⁰¹'s and n²⁰² pieces of Ra²⁰²'s each independently represent an alkyl group having 1 or more and 10 or less carbon atoms, an aryl group having 6 or more and 12 or less carbon atoms, or an alkoxy group having 1 or more and 6 or less carbon atoms.

In Formula (A3), n³⁰¹ and n³⁰² each independently represent an integer of 0 or greater and 4 or less, and n³⁰¹ pieces of Ra³⁰¹'s and n³⁰² pieces of Ra³⁰²'s each independently represent an alkyl group having 1 or more and 10 or less carbon atoms, an aryl group having 6 or more and 12 or less carbon atoms, or an alkoxy group having 1 or more and 6 or less carbon atoms.

In Formula (A4), n⁴⁰¹ represents an integer of 0 or greater and 6 or less, and n⁴⁰¹ pieces of Ra⁴⁰¹'s each independently represent an alkyl group having 1 or more and 10 or less carbon atoms, an aryl group having 6 or more and 12 or less carbon atoms, or an alkoxy group having 1 or more and 6 or less carbon atoms.

In Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2. Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

In the present disclosure, the compound represented by Formula (1) is referred to as a perinone compound (1), and the compound represented by Formula (2) is referred to as a perinone compound (2).

In a case where the photosensitive layer of the photoreceptor according to the present exemplary embodiment is a lamination type photosensitive layer formed of a charge generation layer and a charge transport layer as in the photoreceptor 10A shown in FIG. 1, at least the charge transport layer contains the polyester resin (1). The charge generation layer may or may not contain the polyester resin (1).

The photoreceptor according to the present exemplary embodiment is formed such that a difference in electrical properties between an initial stage and a final stage of repeated image formation is small, burn-in ghosts are unlikely to occur in an image, and these effects are realized over a relatively wide region where charging intensity and exposure intensity are set. Here, the term “burn-in ghost” denotes an image defect in which the surface potential of a photosensitive layer in a region with a large exposure history decreases and thus the density of a halftone image increases.

The mechanism by which the photoreceptor according to the present exemplary embodiment exhibits the above-described effects is presumed as follows.

It is known that satisfactory initial electrical properties can be obtained in a case of using the perinone compound (1) and/or the perinone compound (2) in an undercoat layer.

Here, in a case where a resin other than the polyester resin (1) is used in a photosensitive layer (charge transport layer in a case of a lamination type photosensitive layer), a difference between an electron injection property into an undercoat layer from a photosensitive layer (charge generation layer in a case of a lamination type photosensitive layer) during exposure and a positive hole injection property into a charge transport material from a charge generation material in a photosensitive layer (into a charge transport layer from a charge generation layer in a case of a lamination type photosensitive layer) is large, and thus the charge is considered to be gradually accumulated due to repeated exposure and charging. As a result, the difference in electrical properties between the initial stage and the final stage of repeated image formation is large.

Further, it is considered that the accumulation of the charges is conspicuous in a portion with a large exposure history, and as a result, burn-in ghosts occur in the image.

Further, a change in setting of conditions for charging and exposure is considered to lead to drastic fluctuation in the difference between “electron injection property” and “positive hole injection property” described above. As a result, the difference in electrical properties between the initial stage and the final stage of repeated image formation and the appearance of burn-in ghosts also change.

Meanwhile, in a case where the polyester resin (1) is used in the photosensitive layer (charge transport layer in a case of the lamination type photosensitive layer), the difference between “electron injection property” and “positive hole injection property” described above is considered to be small.

As a result, the difference in electrical properties between the initial stage and the final stage of repeated image formation is small, and burn-in ghosts is unlikely to occur in an image. Further, these effects are realized over a relatively wide region where conditions for charging and exposure are set.

In the photoreceptor according to the present exemplary embodiment, the mass proportion of the polyester resin (1) in the photosensitive layer is 15% by mass or greater. In a case where the mass proportion of the polyester resin (1) in the photosensitive layer is less than 15% by mass, the film strength and crack resistance of the photosensitive layer are insufficient, and the maintainability of electrical properties is degraded. From the viewpoint of suppressing this phenomenon, the mass proportion of the polyester resin (1) in the photosensitive layer is 15% by mass or greater, for example, preferably 20% by mass or greater, and more preferably 25% by mass or greater.

From the viewpoint of initial electrical properties, the mass proportion of the polyester resin (1) in the photosensitive layer is, for example, preferably 80% by mass or less, more preferably 75% by mass or less, and still more preferably 70% by mass or less.

In the photoreceptor according to the present exemplary embodiment, the mass proportion of the perinone compound (the total mass proportion of the perinone compound (1) and the perinone compound (2)) in the undercoat layer is, for example, preferably 30% by mass or greater, more preferably 40% by mass or greater, and still more preferably 50% by mass or greater from the viewpoint of imparting the electrical properties appropriate for electrophotography to the undercoat layer.

The mass proportion of the perinone compound (the total mass proportion of the perinone compound (1) and the perinone compound (2)) in the undercoat layer is, for example, preferably 90% by mass or less, more preferably 80% by mass or less, and still more preferably 70% by mass or less from the viewpoints of the flexibility and the elasticity of the undercoat layer.

Hereinafter, the perinone compound, the polyester resin (1), and each layer of the photoreceptor will be sequentially described in detail.

### Perinone Compound (1) and Perinone Compound (2)

The perinone compound (1) is a compound represented by Formula (1). The perinone compound (2) is a compound represented by Formula (2).

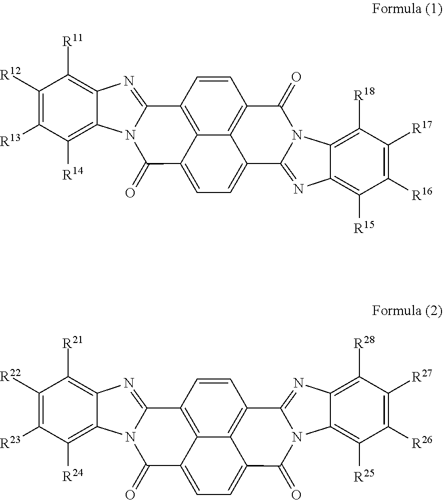

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R¹¹ and R¹², R¹² and R¹³, and R¹³ and R¹⁴ may be each independently linked to each other to form a ring. R¹⁵ and R¹⁶, R¹⁶ and R¹⁷, and R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R²¹ and R²², R²² and R²³, and R²³ and R²⁴ may be each independently linked to each other to form a ring. R²⁵ and R²⁶, R²⁶ and R²⁷, and R²⁷ and R²⁸ may be each independently linked to each other to form a ring.

Examples of the alkyl group represented by R¹¹ to R¹⁸ in Formula (1) include substituted or unsubstituted alkyl groups.

Examples of the unsubstituted alkyl group represented by R¹¹ to R¹⁸ in Formula (1) include a linear alkyl group having 1 or more and 20 or less carbon atoms (for example, preferably 1 or more and 10 or less carbon atoms and more preferably 1 or more and 6 or less carbon atoms), a branched alkyl group having 3 or more and 20 or less carbon atoms (for example, preferably 3 or more and 10 or less carbon atoms), and a cyclic alkyl group having 3 or more and 20 or less carbon atoms (for example, preferably 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups formed by these monocyclic alkyl groups being linked to each other.

Among these, for example, a linear alkyl group such as a methyl group or an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, or an iodine atom).

Examples of the alkoxy group that substitutes the hydrogen atom in the alkyl group include the same groups as the groups for the unsubstituted alkoxy group represented by R¹¹ to R¹⁸ in Formula (1).

Examples of the alkoxy group represented by R¹¹ to R¹⁸ in Formula (1) include a substituted or unsubstituted alkoxy group.

Examples of the unsubstituted alkoxy group represented by R¹¹ to R¹⁸ in Formula (1) include a linear, branched, or cyclic alkoxy group having 1 or more and 10 or less carbon atoms (for example, preferably 1 or more and 6 or less carbon atoms and more preferably 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among these, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, or an iodine atom).

Examples of the aryl group that substitutes a hydrogen atom in the alkoxy group include the same groups as the groups for the unsubstituted aryl group represented by R¹¹ to R¹⁸ in Formula (1).

Examples of the alkoxycarbonyl group that substitutes a hydrogen atom in the alkoxy group include the same groups as the groups for the unsubstituted alkoxycarbonyl group represented by R¹¹ to R¹⁸ in Formula (1).

Examples of the aryloxycarbonyl group that substitutes a hydrogen atom in the alkoxy group include the same groups as the groups for the unsubstituted aryloxycarbonyl group represented by R¹¹ to R¹⁸ in Formula (1).

Examples of the aralkyl group represented by R¹¹ to R¹⁸ in Formula (1) include a substituted or unsubstituted aralkyl group.

In Formula (1), as the unsubstituted aralkyl group represented by R¹¹ to R¹⁸, for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, an aryloxycarbonyl group, and a halogen atom (such as a fluorine atom, a bromine atom, or an iodine atom).

Examples of the alkoxy group that substitutes a hydrogen atom in the aralkyl group include the same groups as the groups for the unsubstituted alkoxy group represented by R¹¹ to R¹⁸ in Formula (1).

Examples of the alkoxycarbonyl group that substitutes a hydrogen atom in the aralkyl group include the same groups as the groups for the unsubstituted alkoxycarbonyl group represented by R¹¹ to R¹⁸ in Formula (1).

Examples of the aryloxycarbonyl group that substitutes a hydrogen atom in the aralkyl group include the same groups as the groups for the unsubstituted aryloxycarbonyl group represented by R¹¹ to R¹⁸ in Formula (1).

Examples of the aryl group represented by R¹¹ to R¹⁸ in Formula (1) include a substituted or unsubstituted aryl group.

As the unsubstituted aryl group represented by R¹¹ to R¹⁸ in Formula (1), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarter anthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubisenyl group, and a coronenyl group. Among these, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, or an iodine atom).

Examples of the alkyl group that substitutes a hydrogen atom in the aryl group include the same groups as the groups for the unsubstituted alkyl group represented by R¹¹ to R¹⁸ in Formula (1).

Examples of the alkoxy group that substitutes a hydrogen atom in the aryl group include the same groups as the groups for the unsubstituted alkoxy group represented by R¹¹ to R¹⁸ in Formula (1).

Examples of the alkoxycarbonyl group that substitutes a hydrogen atom in the aryl group include the same groups as the groups for the unsubstituted alkoxycarbonyl group represented by R¹¹ to R¹⁸ in Formula (1).

Examples of the aryloxycarbonyl group that substitutes a hydrogen atom in the aryl group include the same groups as the groups for the unsubstituted aryloxycarbonyl group represented by R¹¹ to R¹⁸ in Formula (1).

Examples of the aryloxy group represented by R¹¹ to R¹⁸ in Formula (1) (—O—Ar, Ar represent an aryl group) include a substituted or unsubstituted aryloxy group.

As the unsubstituted aryloxy group represented by R¹¹ to R¹⁸ in Formula (1), for example, an aryloxy group having 6 or more and 30 or less carbon atoms is preferable, an aryloxy group having 6 or more and 14 or less carbon atoms is more preferable, and an aryloxy group having 6 or more and 10 or less carbon atoms is still more preferable.

Examples of the aryloxy group having 6 or more and 30 or less carbon atoms include a phenyloxy group (phenoxy group), a biphenyloxy group, a 1-naphthyloxy group, a 2-naphthyloxy group, a 9-anthryloxy group, a 9-phenanthryloxy group, a 1-pyrenyloxy group, a 5-naphthacenyloxy group, a 1-indenyloxy group, a 2-azulenyloxy group, a 9-fluorenyloxy group, a biphenylenyloxy group, an indacenyloxy group, a fluoranthenyloxy group, an acenaphthylenyloxy group, an aceanthryleneyloxy group, a phenalenyloxy group, a fluorenyloxy group, an anthryloxy group, a bianthracenyloxy group, a teranthracenyloxy group, a quarter anthracenyloxy group, an anthraquinolyloxy group, a phenanthryloxy group, a triphenylenyloxy group, a pyrenyloxy group, a chrysenyloxy group, a naphthacenyloxy group, a preadenyloxy group, a picenyloxy group, a perylenyloxy group, a pentaphenyloxy group, a pentacenyloxy group, a tetraphenylenyloxy group, a hexaphenyloxy group, a hexacenyloxy group, a rubisenyloxy group, and a coronenyloxy group. Among these, for example, a phenyloxy group (phenoxy group) is preferable.

Examples of the substituent in the aryloxy group include an alkyl group, an alkoxycarbonyl group, an aryloxycarbonyl group, and a halogen atom (such as a fluorine atom, a bromine atom, or an iodine atom).

Examples of the alkyl group that substitutes a hydrogen atom in the aryloxy group include the same groups as the groups for the unsubstituted alkyl group represented by R¹¹ to R¹⁸ in Formula (1).

Examples of the alkoxycarbonyl group that substitutes a hydrogen atom in the aryloxy group include the same groups as the groups for the unsubstituted alkoxycarbonyl group represented by R¹¹ to R¹⁸ in Formula (1).

Examples of the aryloxycarbonyl group that substitutes a hydrogen atom in the aryloxy group include the same groups as the groups for the unsubstituted aryloxycarbonyl group represented by R¹¹ to R¹⁸ in Formula (1).

Examples of the alkoxycarbonyl group represented by R¹¹ to R¹⁸ (—CO—OR, R represent an alkyl group) in Formula (1) include a substituted or unsubstituted alkoxycarbonyl group.

The number of carbon atoms of the alkyl chain in the unsubstituted alkoxycarbonyl group represented by R¹¹ to R¹⁸ in Formula (1) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, or an iodine atom).

Examples of the aryl group that substitutes a hydrogen atom in the alkoxycarbonyl group include the same groups as the groups for the unsubstituted aryl group represented by R¹¹ to R¹⁸ in Formula (1).

Examples of the aryloxycarbonyl group represented by R¹¹ to R¹⁸ (—CO—OAr, Ar represents an aryl group) in Formula (1) include a substituted or unsubstituted aryloxycarbonyl group.

The number of carbon atoms of the aryl group in the unsubstituted aryloxycarbonyl group represented by R¹¹ to R¹⁸ in Formula (1) is, for example, preferably 6 or more and 30 or less, more preferably 6 or more and 14 or less, and still more preferably 6 or more and 10 or less.

Examples of the aryloxycarbonyl group containing an aryl group with 6 or more and 30 or less carbon atoms include a phenoxycarbonyl group, a biphenyloxycarbonyl group, a 1-naphthyloxycarbonyl group, a 2-naphthyloxycarbonyl group, a 9-anthryloxycarbonyl group, a 9-phenanthryloxycarbonyl group, a 1-pyrenyloxycarbonyl group, a 5-naphthacenyloxycarbonyl group, a 1-indenyloxycarbonyl group, a 2-azulenyloxycarbonyl group, a 9-fluorenyloxycarbonyl group, a biphenylenyloxycarbonyl group, an indacenyloxycarbonyl group, a fluoranthenyloxycarbonyl group, an acenaphthylenyloxycarbonyl group, an aceanthryleneyloxycarbonyl group, a phenalenyloxycarbonyl group, a fluorenyloxycarbonyl group, an anthryloxycarbonyl group, a bianthracenyloxycarbonyl group, a teranthracenyloxycarbonyl group, a quarter anthracenyloxycarbonyl group, an anthraquinolyloxycarbonyl group, a phenanthryloxycarbonyl group, a triphenylenyloxycarbonyl group, a pyrenyloxycarbonyl group, a chrysenyloxycarbonyl group, a naphthacenyloxycarbonyl group, a preadenyloxycarbonyl group, a picenyloxycarbonyl group, a perylenyloxycarbonyl group, a pentaphenyloxycarbonyl group, a pentacenyloxycarbonyl group, a tetraphenylenyloxycarbonyl group, a hexaphenyloxycarbonyl group, a hexacenyloxycarbonyl group, a rubisenyloxycarbonyl group, and a coronenyloxycarbonyl group. Among these, for example, a phenoxycarbonyl group is preferable.

Examples of the substituent in the aryloxycarbonyl group include an alkyl group, a hydroxy group, and a halogen atom (such as a fluorine atom, a bromine atom, or an iodine atom).

Examples of the alkyl group that substitutes a hydrogen atom of the aryloxycarbonyl group include the same groups as the groups for the unsubstituted alkyl group represented by R¹¹ to R¹⁸ in Formula (1).

Examples of the alkoxycarbonylalkyl group represented by R¹¹ to R¹⁸ (—(CₙH₂ₙ)—CO—OR, R represents an alkyl group, and n represents an integer of 1 or greater) in Formula (1) include a substituted or unsubstituted alkoxycarbonylalkyl group.

Examples of the alkoxycarbonyl group (—CO—OR) in the unsubstituted alkoxycarbonylalkyl group represented by R¹¹ to R¹⁸ in Formula (1) include the same groups as the groups for the alkoxycarbonyl group represented by R¹¹ to R¹⁸ in Formula (1).

Examples of the alkylene chain (—CₙH₂ₙ—) in the unsubstituted alkoxycarbonylalkyl group represented by R¹¹ to R¹⁸ in Formula (1) include a linear alkylene chain having 1 or more and 20 or less carbon atoms (for example, preferably 1 or more and 10 or less carbon atoms and more preferably 1 or more and 6 or less carbon atoms), a branched alkylene chain having 3 or more and 20 or less carbon atoms (for example, preferably 3 or more and 10 or less carbon atoms), and a cyclic alkylene chain having 3 or more and 20 or less carbon atoms (for example, preferably 3 or more and 10 or less carbon atoms).

Examples of the linear alkylene chain having 1 or more and 20 or less carbon atoms include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, an n-dodecylene group, a tridecylene group, an n-tetradecylene group, an n-pentadecylene group, an n-heptadecylene group, an n-octadecylene group, an n-nonadecylene group, and an n-icosylene group.

Examples of the branched alkylene chain having 3 or more and 20 or less carbon atoms include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isododecylene group, a sec-dodecylene group, a tert-dodecylene group, a tert-tetradecylene group, and a tert-pentadecylene group.

Examples of the cyclic alkylene chain having 3 or more and 20 or less carbon atoms include a cyclopropylene group, a cyclobutylene group, a cyclopentylene group, a cyclohexylene group, a cycloheptyrene group, a cyclooctylene group, a cyclononylene group, and a cyclodecylene group.

Examples of the substituent in the alkoxycarbonylalkyl group include an aryl group, a hydroxy group, and a halogen atom (such as a fluorine atom, a bromine atom, or an iodine atom).

Examples of the aryl group that substitutes a hydrogen atom of the alkoxycarbonylalkyl group include the same groups as the groups for the unsubstituted aryl group represented by R¹¹ to R¹⁸ in Formula (1).

Examples of the aryloxycarbonylalkyl groups represented by R¹¹ to R¹⁸ (—(CₙH₂ₙ)—CO—OAr, Ar represents an aryl group, and n represents an integer of 1 or greater) in Formula (1) include a substituted or unsubstituted aryloxycarbonylalkyl group.

Examples of the aryloxycarbonyl group (—CO—OAr, Ar represents an aryl group) in the unsubstituted aryloxycarbonylalkyl group represented by R¹¹ to R¹⁸ in Formula (1) include the same groups as the groups for the aryloxycarbonyl group represented by R¹¹ to R¹⁸ in Formula (1).

Examples of the alkylene chain (—CₙH₂ₙ—) in the unsubstituted aryloxycarbonylalkyl group represented by R¹¹ to R¹⁸ in Formula (1) include the same groups as the groups for the alkylene chain in the alkoxycarbonylalkyl group represented by R¹¹ to R¹⁸ in Formula (1).

Examples of the substituent in the aryloxycarbonylalkyl group include an alkyl group, a hydroxy group, and a halogen atom (such as a fluorine atom, a bromine atom, or an iodine atom).

Examples of the alkyl group that substitutes a hydrogen atom of the aryloxycarbonylalkyl group include the same groups as the groups for the unsubstituted alkyl group represented by R¹¹ to R¹⁸ in Formula (1).

Examples of the halogen atom represented by R¹¹ to R¹⁸ in Formula (1) include a fluorine atom, a chlorine atom, a bromine atom, and an iodine atom.

Examples of the ring structure formed by R¹¹ and R¹², R¹² and R¹³, R¹³ and R¹⁴, R¹⁵ and R¹⁶, R¹⁶ and R¹⁷, or R¹⁷ and R¹⁸ in Formula (1) being linked to each other include a benzene ring and a fused ring having 10 or more and 18 or less carbon atoms (such as a naphthalene ring, an anthracene ring, a phenanthrene ring, a chrysene ring (benzo[α]phenanthrene ring), a tetracene ring, a tetraphene ring (benzo[α]anthracene ring), or a triphenylene ring). Among these, for example, a benzene ring is preferable as the ring structure to be formed.

Examples of the alkyl group represented by R²¹ to R²⁸ in Formula (2) include the same groups as the groups for the alkyl group represented by R¹¹ to R¹⁸ in Formula (1).

Examples of the alkoxy groups represented by R²¹ to R²⁸ in Formula (2) include the same groups as the groups for the alkoxy group represented by R¹¹ to R¹⁸ in Formula (1).

Examples of the aralkyl group represented by R²¹ to R²⁸ in Formula (2) include the same groups as the groups for the aralkyl group represented by R¹¹ to R¹⁸ in Formula (1).

Examples of the aryl group represented by R²¹ to R²⁸ in Formula (2) include the same groups as the groups for the aryl group represented by R¹¹ to R¹⁸ in Formula (1).

Examples of the aryloxy group represented by R²¹ to R²⁸ in Formula (2) include the same groups as the groups for the aryloxy group represented by R¹¹ to R¹⁸ in Formula (1).

Examples of the alkoxycarbonyl group represented by R²¹ to R²⁸ in Formula (2) include the same groups as the groups for the alkoxycarbonyl group represented by R¹¹ to R¹⁸ in Formula (1).

Examples of the aryloxycarbonyl group represented by R²¹ to R²⁸ in Formula (2) include the same groups as the groups for the aryloxycarbonyl group represented by R¹¹ to R¹⁸ in Formula (1).

Examples of the alkoxycarbonylalkyl group represented by R²¹ to R²⁸ in Formula (2) include the same groups as the groups for the alkoxycarbonylalkyl group represented by R¹¹ to R¹⁸ in Formula (1).

Examples of the aryloxycarbonylalkyl group represented by R²¹ to R²⁸ in Formula (2) include the same groups as the groups for the aryloxycarbonylalkyl group represented by R¹¹ to R¹⁸ in Formula (1).

Examples of the halogen atom represented by R²¹ to R²⁸ in Formula (2) include the same atoms as the atoms for the halogen atom represented by R¹¹ to R¹⁸ in Formula (1).

Examples of the ring structure formed by R²¹ and R²², R²² and R²³, R²³ and R²⁴, R²⁵ and R²⁶, R²⁶ and R²⁷, or R²⁷ and R²⁸ in Formula (2) being linked to each other include a benzene ring and a fused ring having 10 or more and 18 or less carbon atoms (such as a naphthalene ring, an anthracene ring, a phenanthrene ring, a chrysene ring (benzo[α]phenanthrene ring), a tetracene ring, a tetraphene ring (benzo[α]anthracene ring), or a triphenylene ring). Among these, for example, a benzene ring is preferable as the ring structure to be formed.

It is preferable that R¹¹, R¹², R¹³, R¹⁴, R¹⁵, R¹⁶, R¹⁷, and R¹⁸ in Formula (1) each independently represent, for example, a hydrogen atom, an alkyl group, an alkoxycarbonyl group, an aryloxycarbonyl group, an alkoxycarbonylalkyl group, or an aryloxycarbonylalkyl group.

It is more preferable that R¹¹, R¹², R¹³, R¹⁴, R¹⁵, R¹⁶, R¹⁷, and R¹⁸ in Formula (1) each independently represent, for example, a hydrogen atom or an alkyl group. Here, the form of the alkyl group is as described above.

It is particularly preferable that R¹¹, R¹², R¹³, R¹⁴, R¹⁵, R¹⁶, R¹⁷, and R¹⁸ in Formula (1) represent, for example, a hydrogen atom.

It is preferable that R²¹, R²², R²³, R²⁴, R²⁵, R²⁶, R²⁷, and R²⁸ in Formula (2) each independently represent, for example, a hydrogen atom, an alkyl group, an alkoxycarbonyl group, an aryloxycarbonyl group, an alkoxycarbonylalkyl group, or an aryloxycarbonylalkyl group.

It is more preferable that R²¹, R²², R²³, R²⁴, R²⁵, R²⁶, R²⁷, and R²⁸ in Formula (2) each independently represent, for example, a hydrogen atom or an alkyl group. Here, the form of the alkyl group is as described above.

It is particularly preferable that R²¹, R²², R²³, R²⁴, R²⁵, R²⁶, R²⁷, and R²⁸ in Formula (2) represent, for example, a hydrogen atom.

Hereinafter, specific examples of the perinone compound (1) and the perinone compound (2) will be shown, but the present exemplary embodiment is not limited thereto. In the following structural formulae, Ph represents a phenyl group.

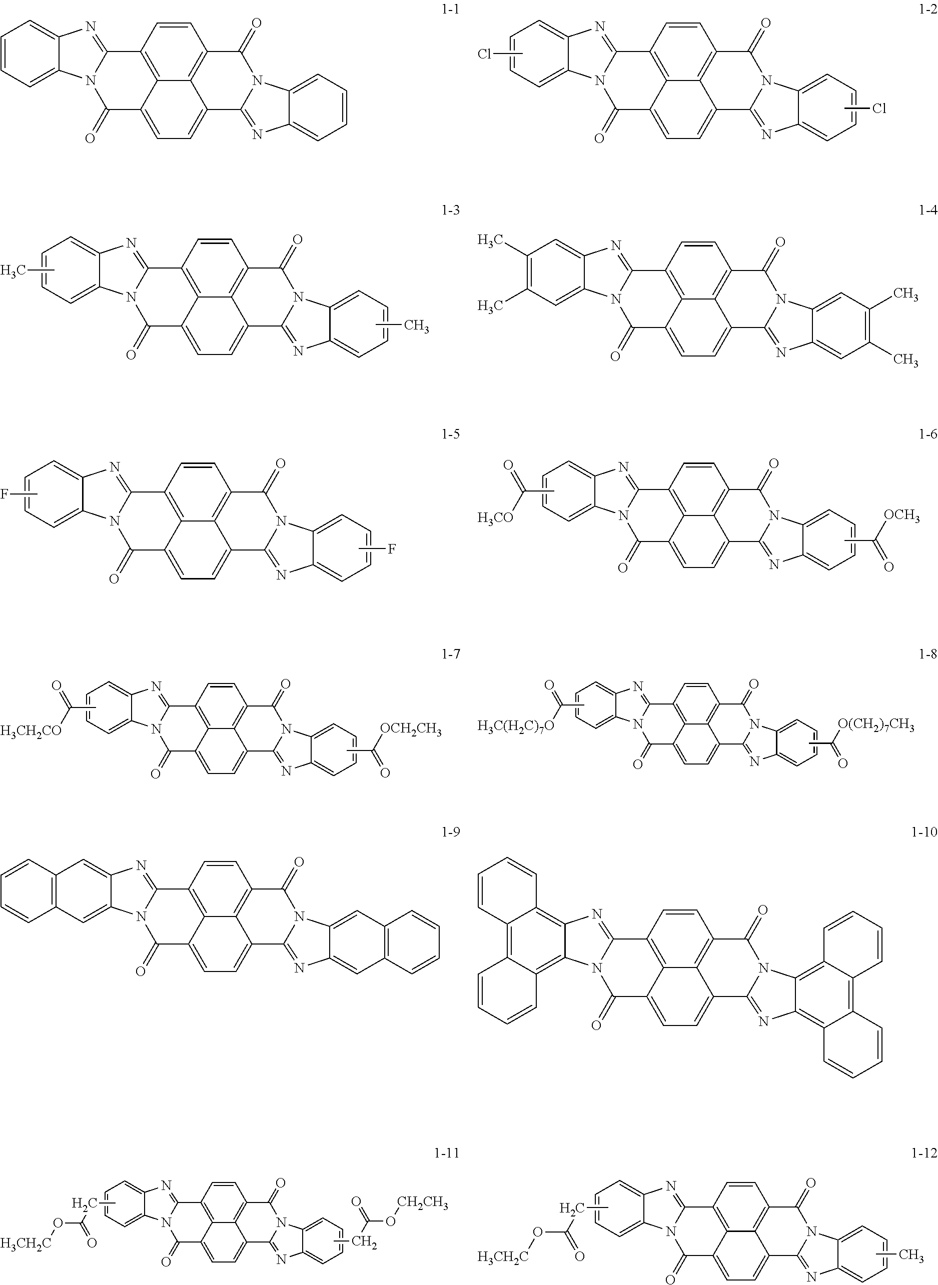

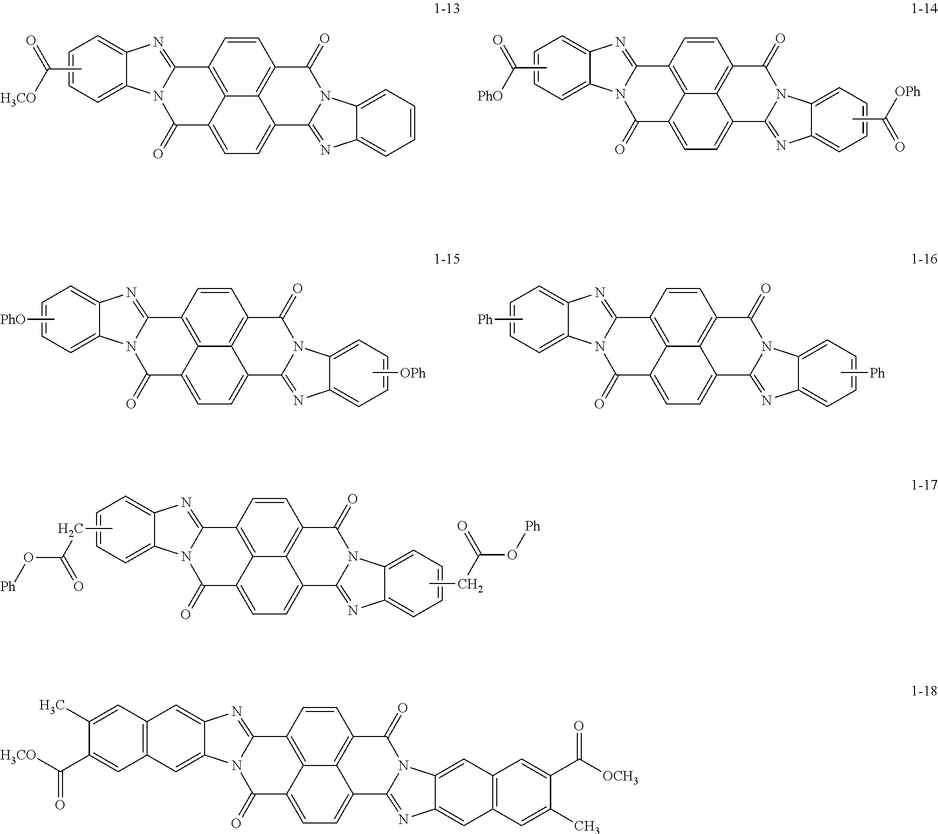

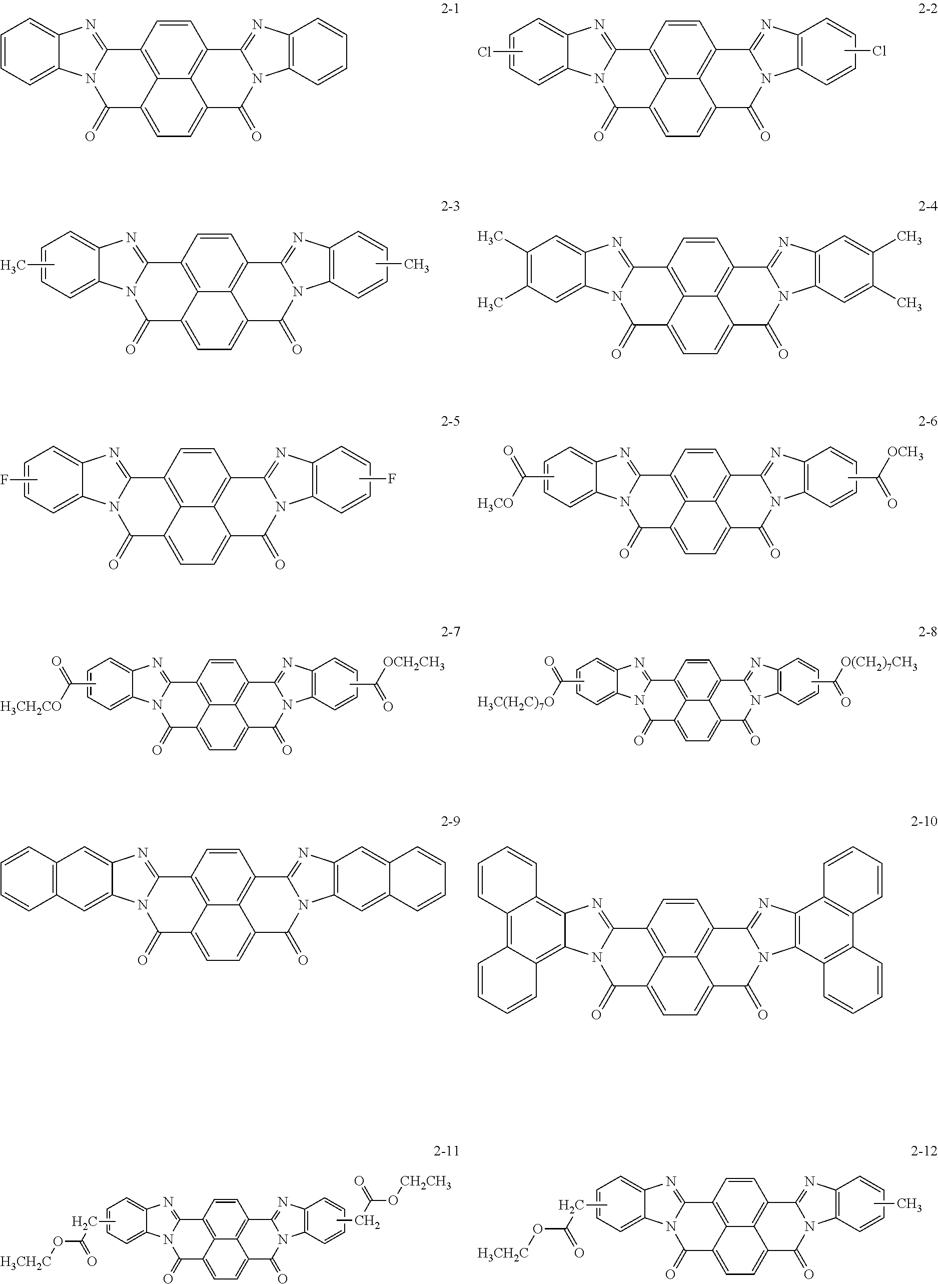

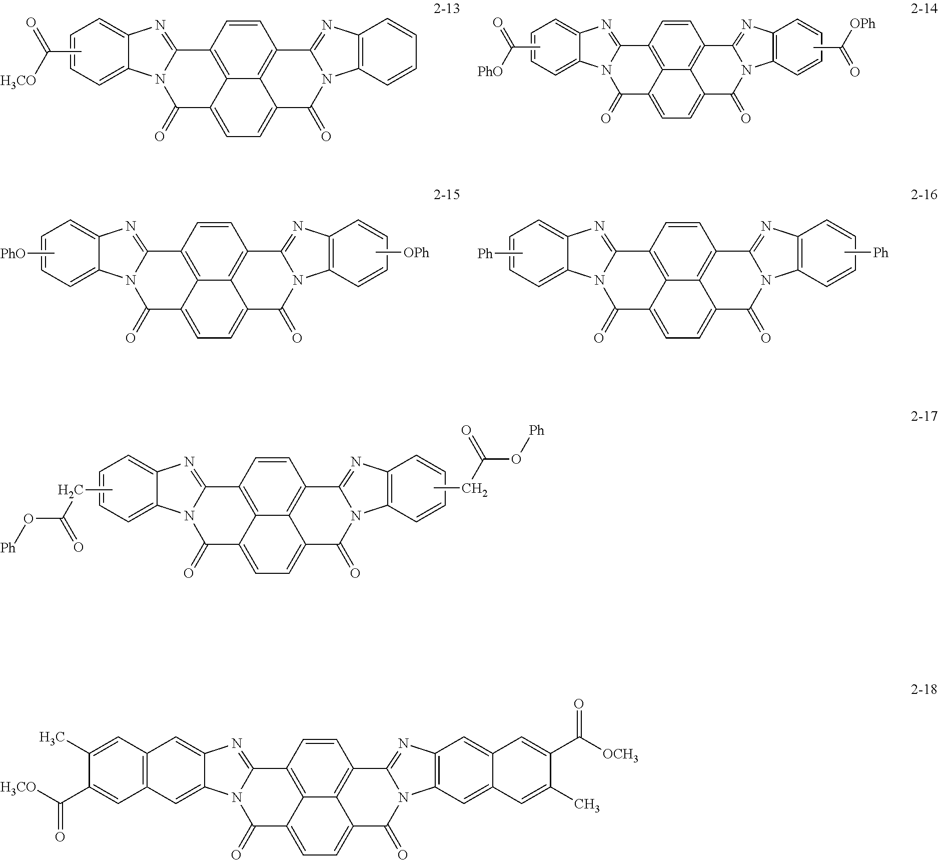

Perinone compounds (2-1) to (2-18) each have an isomer relationship (relationship between a cis form and a trans form) with perinone compounds (1-1) to (1-18). A mixture of isomers tends to be obtained by a synthetic method using the perinone compounds. One of the mixtures of the isomers can be purified by a known purification method.

In an example of the exemplary embodiment, the undercoat layer contains both the perinone compound (1) and the perinone compound (2). Regardless of whether the perinone compound (1) and the perinone compound (2) have an isomer relationship or not, the mass ratio of the perinone compound (1) to the perinone compound (2) (perinone compound (1):perinone compound (2)) is, for example, preferably in a range of 3:97 to 97:3, more preferably in a range of 5:95 to 95:5, and still more preferably in a range of 10:90 to 90:10.

### Polyester Resin (1)

The photosensitive layer (charge transport layer in a case of the lamination type photosensitive layer) contains at least a polyester resin (1) as a binder resin. The polyester resin (1) is a polyester resin having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B).

The polyester resin (1) may have other dicarboxylic acid units in addition to the dicarboxylic acid unit (A). The polyester resin (1) may have other diol units in addition to the diol unit (B).

The dicarboxylic acid unit (A) is at least one selected from the group consisting of a dicarboxylic acid unit (A2) represented by Formula (A2), a dicarboxylic acid unit (A3) represented by Formula (A3), and a dicarboxylic acid unit (A4) represented by Formula (A4).

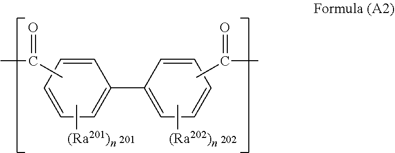

In Formula (A2), n²⁰¹ and n²⁰² each independently represent an integer of 0 or greater and 4 or less, and n²⁰¹ pieces of Ra²⁰¹'s and n²⁰² pieces of Ra²⁰²'s each independently represent an alkyl group having 1 or more and 10 or less carbon atoms, an aryl group having 6 or more and 12 or less carbon atoms, or an alkoxy group having 1 or more and 6 or less carbon atoms.

n²⁰¹ represents, for example, preferably 0, 1, or 2, more preferably 0 or 1, and still more preferably 0.

n²⁰² represents, for example, preferably 0, 1, or 2, more preferably 0 or 1, and still more preferably 0.

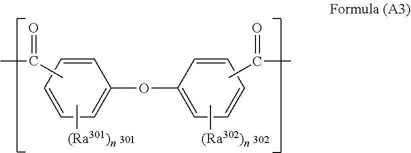

In Formula (A3), n³⁰¹ and n³⁰² each independently represent an integer of 0 or greater and 4 or less, and n³⁰¹ pieces of Ra³⁰¹'s and n³⁰² pieces of Ra³⁰²'s each independently represent an alkyl group having 1 or more and 10 or less carbon atoms, an aryl group having 6 or more and 12 or less carbon atoms, or an alkoxy group having 1 or more and 6 or less carbon atoms.

n³⁰¹ represents, for example, preferably 0, 1, or 2, more preferably 0 or 1, and still more preferably 0.

n³⁰² represents, for example, preferably 0, 1, or 2, more preferably 0 or 1, and still more preferably 0.

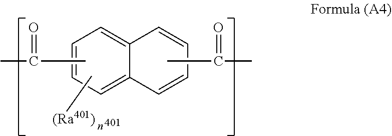

In Formula (A4), n⁴⁰¹ represents an integer of 0 or greater and 6 or less, and n⁴⁰¹ pieces of Ra⁴⁰¹'s each independently represent an alkyl group having 1 or more and 10 or less carbon atoms, an aryl group having 6 or more and 12 or less carbon atoms, or an alkoxy group having 1 or more and 6 or less carbon atoms.

n⁴⁰¹ represents, for example, preferably an integer of 0 or greater and 4 or less, more preferably 0, 1, or 2, and still more preferably 0.

The specific forms and the desired forms of Ra²⁰¹ and Ra²⁰² in Formula (A2), Ra³⁰¹ and Ra³⁰² in Formula (A3), and Ra⁴⁰¹ in Formula (A4) are the same as each other, and thus, hereinafter, Ra²⁰¹, Ra²⁰², Ra³⁰¹, Ra³⁰², and Ra⁴⁰¹ will be collectively referred to as “Ra”.

The alkyl group having 1 or more and 10 or less carbon atoms as Ra may be any of linear, branched, or cyclic. The number of carbon atoms of the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

The aryl group having 6 or more and 12 or less carbon atoms as Ra may be any of a monocycle or a polycycle. The number of carbon atoms of the aryl group is, for example, preferably 6 or more and 10 or less and more preferably 6.

Examples of the aryl group having 6 or more and 12 or less carbon atoms include a phenyl group, a biphenyl group, a 1-naphthyl group, and a 2-naphthyl group.

The alkyl group in the alkoxy group having 1 or more and 6 or less carbon atoms as Ra may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Hereinafter, dicarboxylic acid units (A2-1) to (A2-3) are shown as specific examples of the dicarboxylic acid unit (A2). The dicarboxylic acid unit (A2) is not limited thereto.

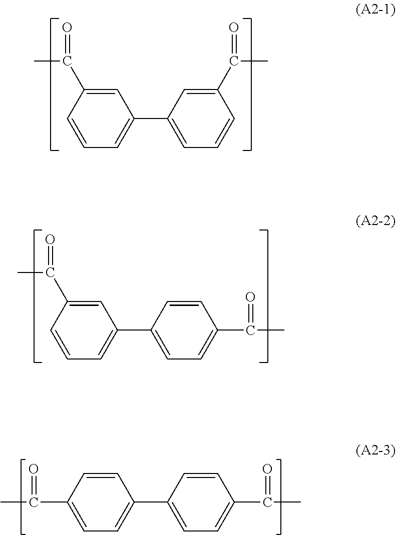

Hereinafter, dicarboxylic acid units (A3-1) and (A3-2) are shown as specific examples of the dicarboxylic acid unit (A3). The dicarboxylic acid unit (A3) is not limited thereto.

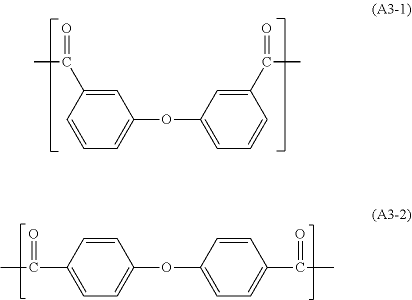

Hereinafter, dicarboxylic acid units (A4-1) to (A4-3) are shown as specific examples of the dicarboxylic acid unit (A4). The dicarboxylic acid unit (A4) is not limited thereto.

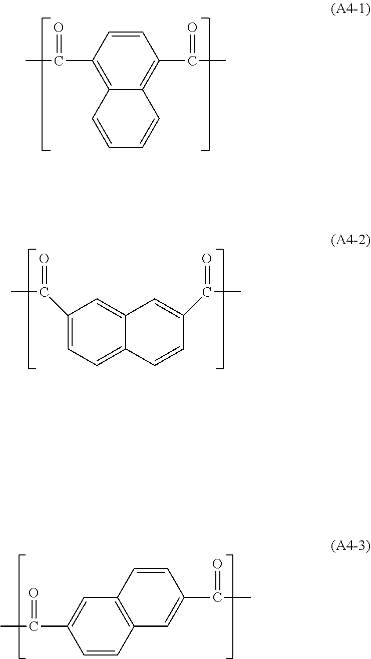

The polyester resin has, for example, preferably at least one selected from the group consisting of (A2-3), (A3-2), and (A4-3), more preferably at least one selected from the group consisting of (A2-3) and (A3-2), and still more preferably at least (A2-3) as the dicarboxylic acid unit (A).

The total mass proportion of the dicarboxylic acid units (A2) to (A4) in the polyester resin (1) is, for example, preferably 15% by mass or greater and 60% by mass or less.

In a case where the total mass proportion of the dicarboxylic acid units (A2) to (A4) is 15% by mass or greater, the abrasion resistance of the photosensitive layer is enhanced. From this viewpoint, the total mass proportion of the dicarboxylic acid units (A2) to (A4) is, for example, more preferably 20% by mass or greater and still more preferably 25% by mass or greater.

In a case where the total mass proportion of the dicarboxylic acid units (A2) to (A4) is 60% by mass or less, peeling of the photosensitive layer can be suppressed. From this viewpoint, the total mass proportion of the dicarboxylic acid units (A2) to (A4) is, for example, more preferably 55% by mass or less and still more preferably 50% by mass or less.

Examples of other dicarboxylic acid units (A) in addition to the dicarboxylic acid units (A2) to (A4) include aliphatic dicarboxylic acid (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower (for example, having 1 or more and 5 or less carbon atoms) alkyl ester units thereof. These dicarboxylic acid units contained in the polyester resin (1) may be used alone or in combination of two or more kinds thereof.

The dicarboxylic acid unit (A) contained in the polyester resin (1) may be used alone or in combination of two or more kinds thereof. That is, the dicarboxylic acid units (A2) to (A4) contained in the polyester resin (1) may be used alone or in combination of two or more kinds thereof.

The diol unit (B) is a constitutional unit represented by Formula (B).

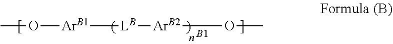

In Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2. Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The aromatic ring as Ar^{B2} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{B2} may be substituted with an alkyl group, an aryl group, an aralkyl group, an alkoxy group, an aryloxy group, a halogen atom, or the like. As the substituent in a case where the aromatic ring as Ar^{B2} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The alkyl group having 1 or more and 20 or less carbon atoms as Rb¹ and Rb² may be linear, branched, or cyclic. The number of carbon atoms of the alkyl group is, for example, preferably 1 or more and 18 or less, more preferably 1 or more and 14 or less, and still more preferably 1 or more and 10 or less.

The aryl group having 6 or more and 12 or less carbon atoms as Rb¹ and Rb² may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Rb¹ and Rb² may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2.

The aryl group in the aralkyl group having 7 or more and 20 or less carbon atoms as Rb¹ and Rb² may be any of a monocycle or a polycycle. The number of carbon atoms of the aryl group is, for example, preferably 6 or more and 10 or less and more preferably 6.

It is preferable that the diol unit (B) includes, for example, at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

The diol unit (B) includes, for example, more preferably at least one selected from the group consisting of a diol unit (B1), a diol unit (B2), a diol unit (B4), a diol unit (B5), and a diol unit (B6), still more preferably at least one selected from the group consisting of a diol unit (B1), a diol unit (B2), a diol unit (B5), and a diol unit (B6), even still more preferably at least one selected from the group consisting of a diol unit (B1), a diol unit (B2), and a diol unit (B6), and most preferably at least one selected from the group consisting of a diol unit (B1) and a diol unit (B2).

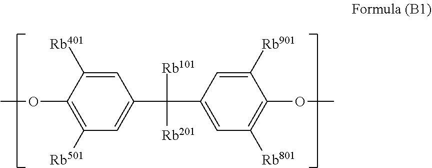

In Formula (B1), Rb¹⁰¹ represents a branched alkyl group having 4 or more and 20 or less carbon atoms, Rb²⁰¹ represents a hydrogen atom or an alkyl group having 1 or more and 3 or less carbon atoms, and Rb⁴⁰¹, Rb⁵⁰¹, Rb⁸⁰¹, and Rb⁹⁰¹ each independently represent a hydrogen atom, an alkyl group having 1 or more and 4 or less carbon atoms, an alkoxy group having 1 or more and 6 or less carbon atoms, or a halogen atom.

The number of carbon atoms of the branched alkyl group having 4 or more and 20 or less carbon atoms as Rb¹⁰¹ is, for example, preferably 4 or more and 16 or less, more preferably 4 or more and 12 or less, and still more preferably 4 or more and 8 or less. Specific examples of Rb¹⁰¹ include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

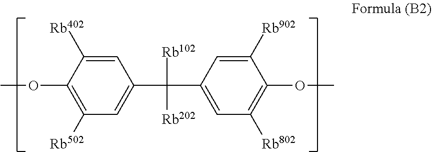

In Formula (B2), Rb¹⁰² represents a linear alkyl group having 4 or more and 20 or less carbon atoms, Rb²⁰² represents a hydrogen atom or an alkyl group having 1 or more and 3 or less carbon atoms, and Rb⁴⁰², Rb⁵⁰², Rb⁸⁰², and Rb⁹⁰² each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 4 or more and 20 or less carbon atoms as Rb¹⁰² is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

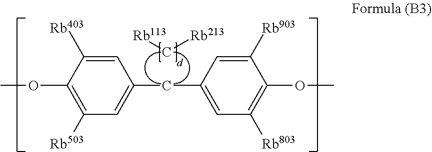

In Formula (B3), Rb¹¹³ and Rb²¹³ each independently represent a hydrogen atom, a linear alkyl group having 1 or more and 3 or less carbon atoms, an alkoxy group having 1 or more and 4 or less carbon atoms, or a halogen atom, d represents an integer of 7 or greater and 15 or less, and Rb⁴⁰³, Rb⁵⁰³, Rb⁸⁰³, and Rb⁹⁰³ each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 1 or more and 3 or less carbon atoms as Rb¹¹³ and Rb²¹³ is, for example, preferably 1 or 2 and more preferably 1. Specific examples of such a group include a methyl group, an ethyl group, and an n-propyl group.

The alkyl group in the alkoxy group having 1 or more and 4 or less carbon atoms as Rb¹¹³ and Rb²¹³ may be linear, branched, or cyclic. The number of carbon atoms of the alkyl group in the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

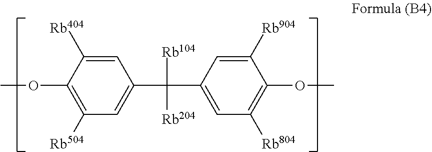

In Formula (B4), Rb¹⁰⁴ and Rb²⁰⁴ each independently represent a hydrogen atom, an alkyl group having 1 or more and 3 or less carbon atoms, and Rb⁴⁰⁴, Rb⁵⁰⁴, Rb⁸⁰⁴, and Rb⁹⁰⁴ each independently represent a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms as Rb¹⁰⁴ may be any of linear, branched, or cyclic. The number of carbon atoms of the alkyl group is, for example, preferably 1 or 2 and more preferably 1. Specific examples of Rb¹⁰⁴ include a methyl group, an ethyl group, an n-propyl group, an isopropyl group, and a cyclopropyl group.

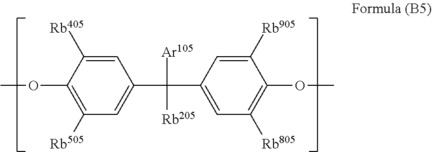

In Formula (B5), Ar¹⁰⁵ represents an aryl group having 6 or more and 12 or less carbon atoms or an aralkyl group having 7 or more and 20 or less carbon atoms, Rb²⁰⁵ represents a hydrogen atom or an alkyl group having 1 or more and 3 or less carbon atoms, and Rb⁴⁰⁵, Rb⁵⁰⁵, Rb⁸⁰⁵, and Rb⁹⁰⁵ each independently represent a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms as Ar¹⁰⁵ may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Ar¹⁰⁵ may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2. The aryl group in the aralkyl group having 7 or more and 20 or less carbon atoms as Ar¹⁰⁵ may be any of a monocycle or a polycycle. The number of carbon atoms of the aryl group is, for example, preferably 6 or more and 10 or less and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

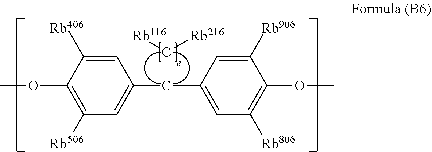

In Formula (B6), Rb¹¹⁶ and Rb²¹⁶ each independently represent a hydrogen atom, a linear alkyl group having 1 or more and 3 or less carbon atoms, an alkoxy group having 1 or more and 4 or less carbon atoms, or a halogen atom, e represents an integer of 4 or greater and 6 or less, and Rb⁴⁰⁶, Rb⁵⁰⁶, Rb⁸⁰⁶, and Rb⁹⁰⁶ each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 1 or more and 3 or less carbon atoms as Rb¹¹⁶ and Rb²¹⁶ is, for example, preferably 1 or 2 and more preferably 1. Specific examples of such a group include a methyl group, an ethyl group, and an n-propyl group.

The alkyl group in the alkoxy group having 1 or more and 4 or less carbon atoms as Rb¹¹⁶ and Rb²¹⁶ may be linear, branched, or cyclic. The number of carbon atoms of the alkyl group in the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

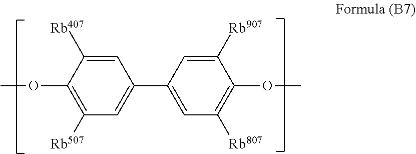

In Formula (B7), Rb⁴⁰⁷, Rb⁵⁰⁷, Rb⁸⁰⁷, and Rb⁹⁰⁷ each independently represent a hydrogen atom, an alkyl group having 1 or more and 4 or less carbon atoms, an alkoxy group having 1 or more and 6 or less carbon atoms, or a halogen atom.

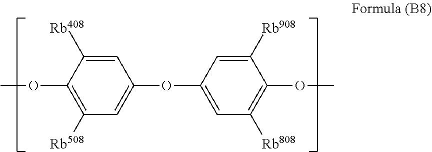

In Formula (B8), Rb⁴⁰⁸, Rb⁵⁰⁸, Rb⁸⁰⁸, and Rb⁹⁰⁸ each independently represent a hydrogen atom, an alkyl group having 1 or more and 4 or less carbon atoms, an alkoxy group having 1 or more and 6 or less carbon atoms, or a halogen atom.

The specific forms and the desired forms of Rb²⁰¹ in Formula (B1), Rb²⁰² in Formula (B2), Rb²⁰⁴ in Formula (B4), and Rb²⁰⁵ in Formula (B5) are the same as each other, and hereinafter, Rb²⁰¹, Rb²⁰², Rb²⁰⁴, and Rb²⁰⁵ will be collectively referred to as “Rb²⁰⁰”.

The alkyl group having 1 or more and 3 or less carbon atoms as Rb²⁰⁰ may be any of linear, branched, or cyclic. The number of carbon atoms of the alkyl group is, for example, preferably 1 or 2 and more preferably 1.

The alkyl group having 1 or more and 3 or less carbon atoms includes a methyl group, an ethyl group, an n-propyl group, an isopropyl group, and a cyclopropyl group.

The specific forms and the desired forms of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, and hereinafter, Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms as Rb⁴⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁴⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

The specific forms and the desired forms of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, and hereinafter, Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms as Rb⁵⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁵⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

The specific forms and the desired forms of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, and hereinafter, Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms as Rb⁸⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁸⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

The specific forms and the desired forms of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, and hereinafter, Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰⁰”.

The alkyl group having 1 or more and 4 or less carbon atoms as Rb⁹⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁹⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Hereinafter, diol units (B1-1) to (B1-6) are shown as specific examples of the diol unit (B1). The diol unit (B1) is not limited thereto.

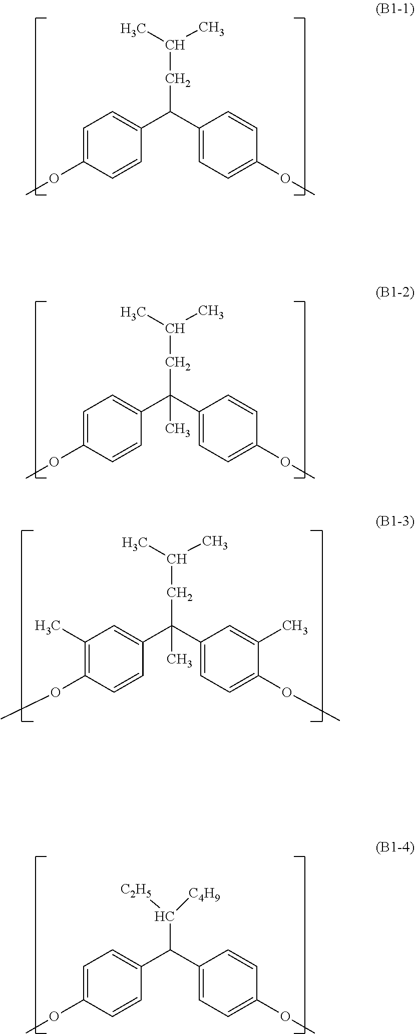

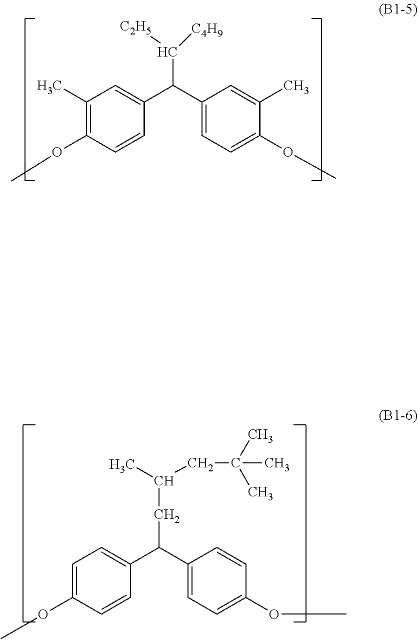

Hereinafter, diol units (B2-1) to (B2-11) are shown as specific examples of the diol unit (B2). The diol unit (B2) is not limited thereto.

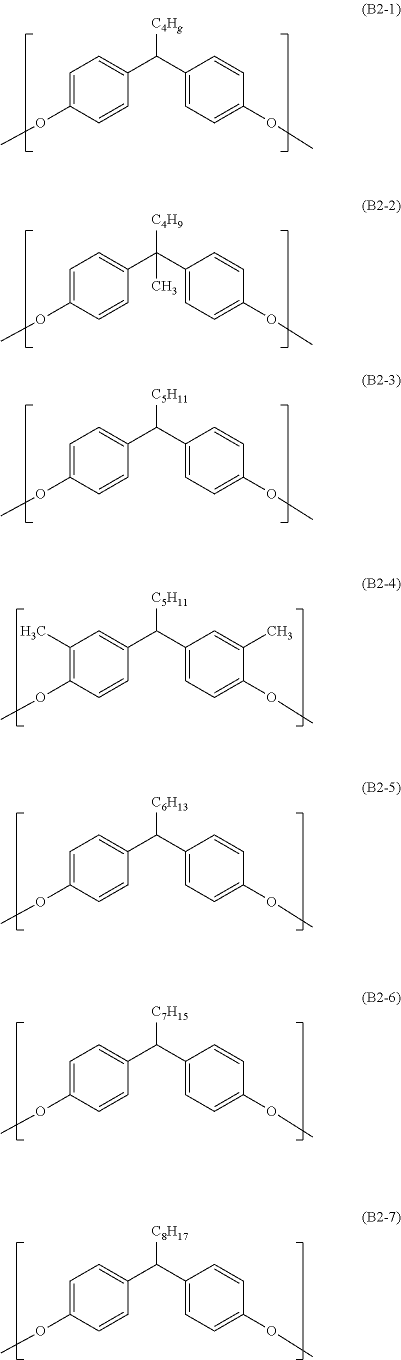

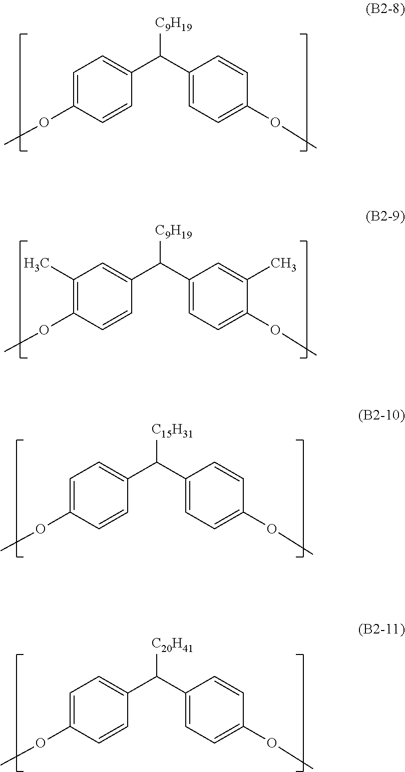

Hereinafter, diol units (B3-1) to (B3-4) are shown as specific examples of the diol unit (B3). The diol unit (B3) is not limited thereto.

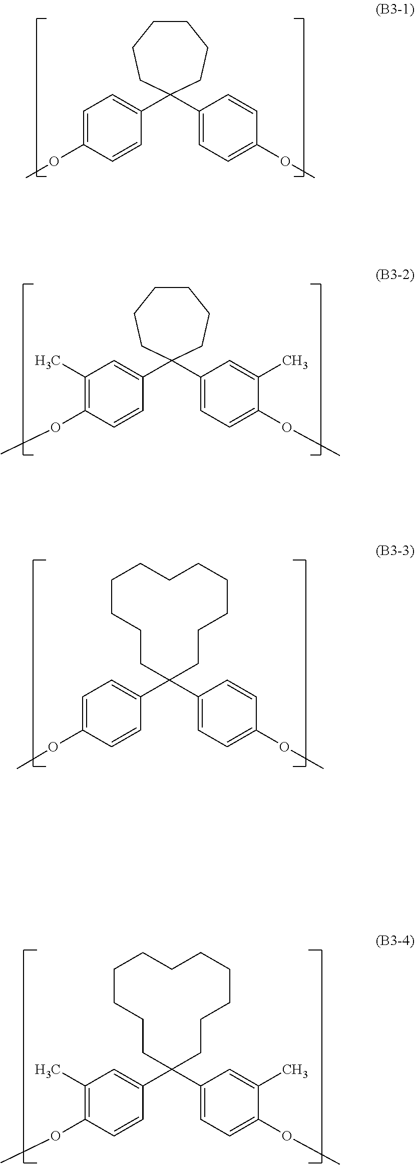

Hereinafter, diol units (B4-1) to (B4-7) are shown as specific examples of the diol unit (B4). The diol unit (B4) is not limited thereto.

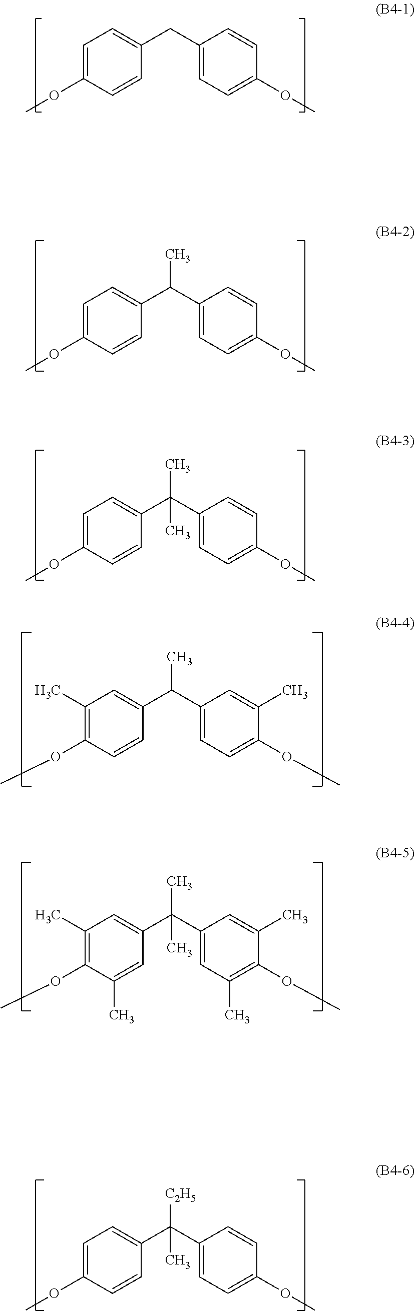

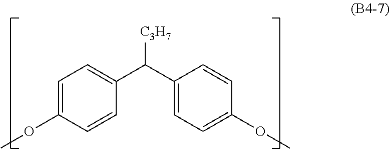

Hereinafter, diol units (B5-1) to (B5-6) are shown as specific examples of the diol unit (B5). The diol unit (B5) is not limited thereto.

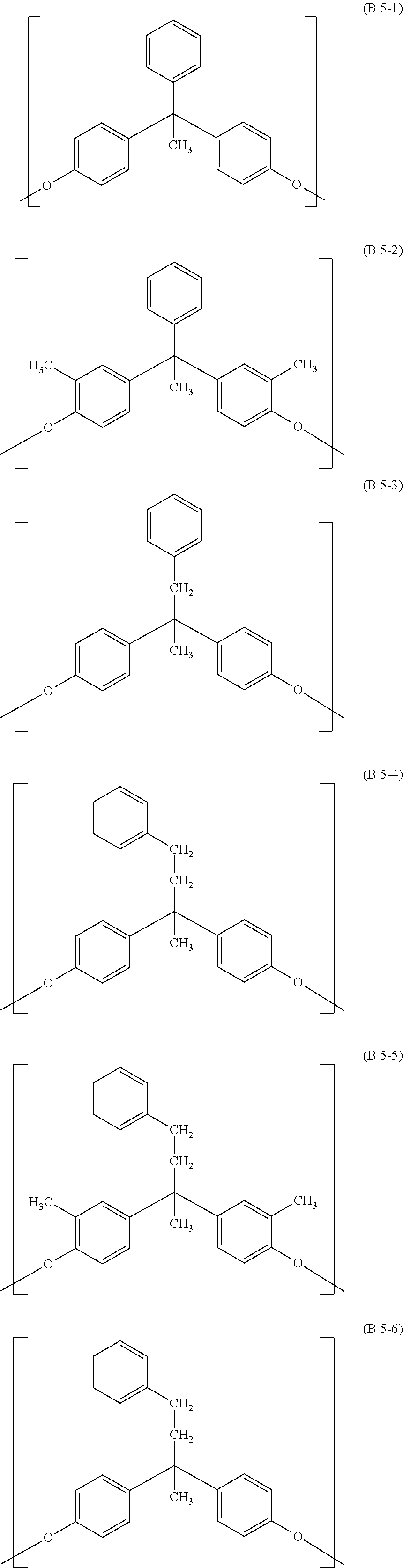

Hereinafter, diol units (B6-1) to (B6-4) are shown as specific examples of the diol unit (B6). The diol unit (B6) is not limited thereto.

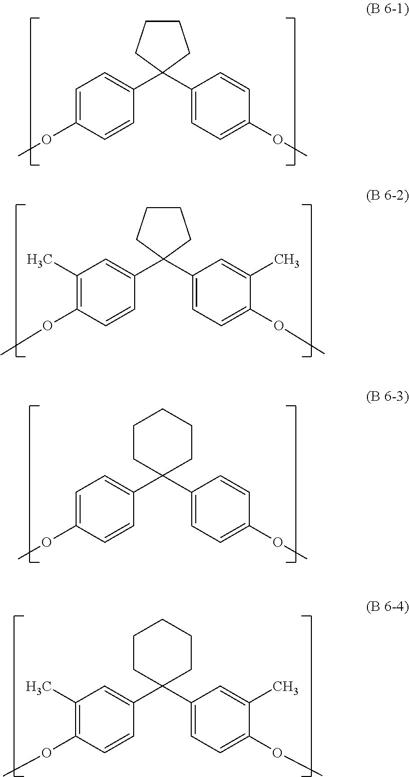

Hereinafter, diol units (B7-1) to (B7-3) are shown as specific examples of the diol unit (B7). The diol unit (B7) is not limited thereto.

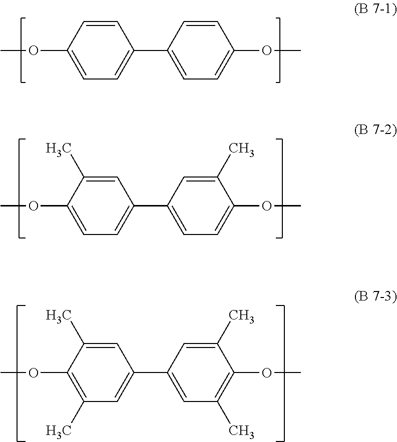

Hereinafter, diol units (B8-1) to (B8-3) are shown as specific examples of the diol unit (B8). The diol unit (B8) is not limited thereto.

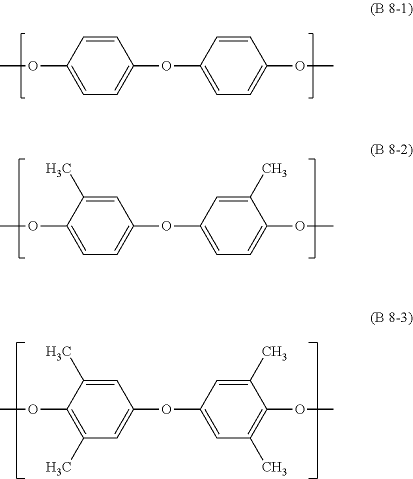

The diol unit (B) contained in the polyester resin (1) may be used alone or in combination of two or more kinds thereof.

The mass proportion of the diol unit (B) in the polyester resin (1) is, for example, preferably 25% by mass or greater and 80% by mass or less.

In a case where the mass proportion of the diol unit (B) is 25% by mass or greater, peeling of the photosensitive layer can be further suppressed. From this viewpoint, the mass proportion of the diol unit (B) is, for example, more preferably 30% by mass or greater and still more preferably 35% by mass or greater.

In a case where the mass proportion of the diol unit (B) is 80% by mass or less, the solubility in a coating solution for forming the photosensitive layer is maintained, and thus the abrasion resistance can be improved. From this viewpoint, the mass proportion of the diol unit (B) is, for example, more preferably 75% by mass or less and still more preferably 70% by mass or less.

Examples of other diol units in addition to the diol unit (B) include aliphatic diol (such as ethylene glycol, diethylene glycol, triethylene glycol, propylene glycol, butanediol, hexanediol, and neopentyl glycol) units and alicyclic diol (such as cyclohexanediol, cyclohexanedimethanol, and hydrogenated bisphenol A) units. These diol units contained in the polyester resin (1) may be used alone or in combination of two or more kinds thereof.

A terminal of the polyester resin (1) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl) propane, 2-phenyl-2-(2-hydroxyphenyl) propane, and 2-phenyl-2-(3-hydroxyphenyl) propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The weight-average molecular weight of the polyester resin (1) is, for example, preferably 30,000 or greater and 300,000 or less, more preferably 40,000 or greater and 250,000 or less, and still more preferably 50,000 or greater and 200,000 or less.

The molecular weight of the polyester resin (1) is a molecular weight measured by gel permeation chromatography (GPC) in terms of polystyrene. The GPC is carried out by using tetrahydrofuran as an eluent.

The polyester resin (1) can be obtained by polycondensing a monomer providing a dicarboxylic acid unit (A), a monomer providing a diol unit (B), and other monomers as necessary using a method of the related art. Examples of the method of polycondensing monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B. Since the interfacial polymerization method enables the reaction to proceed faster than the reaction carried out by the solution polymerization method and also enables suppression of hydrolysis of the divalent carboxylic acid halide, as a result, a high-molecular-weight polyester resin can be obtained.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer contains at least a binder resin and a perinone compound.

The binder resin in the undercoat layer is not particularly limited, and a known resin can be used. Specific examples thereof include polyvinyl alcohol, polyvinyl acetal, polyethylene oxide, casein, polyamide, polyamic acid, polyurethane, polyimide, cellulose, gelatin, polyester, unsaturated polyester, a polyolefin resin, a methacrylic resin, an acrylic resin, polyvinyl chloride, polyvinyl acetate, a vinyl chloride-vinyl acetate-maleic anhydride resin, a silicone resin, a silicone-alkyd resin, a urea resin, a phenol resin, a phenol-formaldehyde resin, a melamine resin, an alkyd resin, an epoxy resin, a hydrolyzable silyl group-containing resin, and a hydrolyzable silane condensate.

It is preferable that the undercoat layer contains, for example, at least polyurethane as a binder resin.

The mass proportion of the polyurethane in the total amount of the binder resin in the undercoat layer is, for example, preferably 60% by mass or greater, more preferably 70% by mass or greater, still more preferably 80% by mass or greater, and may be 100% by mass.

Polyurethane is typically synthesized by a polyaddition reaction between a polyfunctional isocyanate and a polyol.

Examples of the polyfunctional isocyanate include a diisocyanate such as methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, or methylenebis(4-cyclohexyl isocyanate); an isocyanurate obtained by trimerizing the diisocyanate; and a blocked isocyanate in which the isocyanate group of the diisocyanate is blocked with a blocking agent. The polyfunctional isocyanate may be used alone or in combination of two or more kinds thereof.

Examples of the polyol include diols such as ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol, polypropylene glycol, poly(oxytetramethylene) glycol, 4,4′-dihydroxy-diphenyl-2,2-propane, and 4,4′-dihydroxyphenylsulfone.

Examples of the polyol further include polyester polyol, polycarbonate polyol, polycaprolactone polyol, polyether polyol, and polyvinyl butyral.

The polyol may be used alone or in combination of two or more kinds thereof.

The undercoat layer may contain other components in addition to the binder resin and the perinone compound. Hereinafter, other components will be described below.

The undercoat layer may contain at least one of an organic acid metal salt or an organic metal complex. At least one of the organic acid metal salt or the organic metal complex contained in the undercoat layer may be, for example, an organic acid metal salt or an organic metal complex serving as a urethane curing catalyst (that is, a catalyst for the polyaddition reaction between a polyfunctional isocyanate and a polyol) during formation of the undercoat layer.

Examples of the metal constituting the organic acid metal salt or the organic metal complex include bismuth, aluminum, zirconium, zinc, cobalt, iron, nickel, copper, tin, platinum, and palladium. As the organic acid of the organic acid metal salt, for example, a monovalent carboxylic acid is preferable, and the monovalent carboxylic acid is, for example, preferably octylic acid, naphthenic acid, or salicylic acid and more preferably octylic acid.

From the viewpoint of suppressing an increase in residual potential generated in a case of repeated image formation, at least one of the organic acid metal salt or the organic metal complex contained in the undercoat layer is, for example, preferably at least one of an organic acid metal salt or an organic metal complex containing a metal selected from the group consisting of bismuth, aluminum, zirconium, zinc, cobalt, iron, nickel, and copper and more preferably at least one of an organic acid metal salt or an organic metal complex containing a metal selected from the group consisting of bismuth, aluminum, and zirconium.

Examples of the organic acid metal salt or the organic metal complex containing bismuth include bismuth octylate, bismuth naphthenate, and bismuth salicylate; and K-KAT 348, K-KAT XC-C227, K-KAT XK-628, and K-KAT XK-640 (all manufactured by King Industries, Inc.).

Examples of the organic acid metal salt or the organic metal complex containing aluminum include aluminum octylate, aluminum naphthenate, and aluminum salicylate; and K-KAT 5218 (manufactured by King Industries, Inc.).

Examples of the organic acid metal salt or the organic metal complex containing zirconium include zirconium octylate, zirconium naphthenate, and zirconium salicylate; and K-KAT 4205, K-KAT 6212, and K-KATA 209 (manufactured by King Industries, Inc.).

Examples of the organic acid metal salt or the organic metal complex containing zinc include zinc octylate, zinc naphthenate, and zinc salicylate.

Examples of the organic acid metal salt or the organic metal complex containing cobalt include cobalt octylate, cobalt naphthenate, and cobalt salicylate.

Examples of the organic acid metal salt or the organic metal complex containing iron include iron octylate, iron naphthenate, and iron salicylate.

Examples of the organic acid metal salt or the organic metal complex containing nickel include nickel octylate, nickel naphthenate, and nickel salicylate.

Examples of the organic acid metal salt or the organic metal complex containing copper include copper octylate, copper naphthenate, and copper salicylate.

The organic acid metal salt and the organic metal complex may be used alone or in combination of two or more kinds thereof.

In a case where the undercoat layer contains at least one of the organic acid metal salt or the organic metal complex, the total content of the organic acid metal salt and the organic metal complex is, for example, preferably 0.001% by mass or greater and 3% by mass or less, more preferably 0.003% by mass or greater and 2% by mass or less, still more preferably 0.01% by mass or greater and 1% by mass or less, and even still more preferably 0.05% by mass or greater and 0.5% by mass or less with respect to the total amount of the solid content in the undercoat layer.

The undercoat layer may contain inorganic particles. Examples of the inorganic particles include inorganic particles having a powder resistance (volume resistivity) of 1×10² Ω·cm or greater and 1×10¹¹ Ω·cm or less.

Examples of the inorganic particles having the above-described resistance value include metal oxide particles such as tin oxide particles, titanium oxide particles, zinc oxide particles, and zirconium oxide particles. Among these, zinc oxide particles are preferable.

Examples of the inorganic particles other than the examples described above include silica particles and metal titanate compound particles. Examples of the metal titanate compound particles include strontium titanate particles, barium titanate particles, calcium titanate particles, and magnesium titanate particles.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The inorganic particles may be subjected to a surface treatment. The inorganic particles may be used by mixing two or more kinds of particles subjected to different surface treatments or two or more kinds of particles having different particle diameters.

Examples of the surface treatment agent include a silane coupling agent, a titanate-based coupling agent, an aluminum-based coupling agent, and a surfactant. For example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy) silane, 2-(3,4-epoxycyclohexyl) ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used. The treatment amount of the surface treatment agent is, for example, preferably 0.5% by mass or greater and 10% by mass or less with respect to the amount of the inorganic particles.

The undercoat layer may contain, for example, an electron-accepting compound (acceptor compound) together with the inorganic particles, from the viewpoint of enhancing the long-term stability of the electrical properties and the carrier blocking properties.

Examples of the electron-accepting compound include a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

As the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent by stirring, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound is, for example, preferably 0.01% by mass or greater and 20% by mass or less and more preferably 0.01% by mass or greater and 10% by mass or less with respect to the amount of the inorganic particles.

The undercoat layer may contain various additives for improving the charging maintainability, the electrical properties, the environmental stability, and the image quality. Examples of the additives include known materials, for example, an electron-transporting pigment such as an amine compound having an ionization potential of 5.4 eV or greater and 5.9 eV or less, a polycyclic condensed pigment, or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy) silane, 2-(3,4-epoxycyclohexyl) ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Since the perinone compound (1) and the perinone compound (2) are unlikely to be dissolved in, for example, an organic solvent, it is desirable to disperse the perinone compound (1) and the perinone compound (2) in an organic solvent. Examples of a dispersing method include known methods such as a roll mill, a ball mill, a vibration ball mill, an attritor, a sand mill, a colloid mill, and a paint shaker. In a case where the inorganic particles are blended into the undercoat layer, for example, it is desirable that the inorganic particles are also dispersed in an organic solvent by the same dispersing method.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

From the viewpoint of leak resistance, the average thickness of the undercoat layer is, for example, preferably 3 μm or greater, more preferably 4 μm or greater, and still more preferably 5 μm or greater.

From the viewpoint of suppressing an increase in residual potential in a case of repeated use, the average thickness of the undercoat layer is, for example, preferably 50 μm or less, more preferably 40 μm or less, and still more preferably 30 μm or less.

The average thickness of each layer of the photoreceptor is an arithmetic average of the measured values measured by an electromagnetic film thickness meter, and the measurement is performed on a total of 12 measurement sites at the center and in the vicinity of both ends at intervals of 90° in the circumferential direction.

### Interlayer

An interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The average thickness of the interlayer is, for example, preferably 0.1 μm or greater and 3 μm or less.

### Charge Generation Layer

The charge generation layer is, for example, a layer containing a charge generation material and a binder resin. Further, the charge generation layer may be a deposition layer of the charge generation material. The deposition layer of the charge generation material is, for example, appropriate in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, at least one selected from the group consisting of hydroxygallium phthalocyanine, chlorogallium phthalocyanine, dichlorotin phthalocyanine, and titanyl phthalocyanine is preferable, hydroxygallium phthalocyanine and/or chlorogallium phthalocyanine is more preferable, and hydroxygallium phthalocyanine is still more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the electric field intensity in the photosensitive layer is increased, and a decrease in charge due to injection of a charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ω·cm or greater. These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a fine flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The average thickness of the charge generation layer is, for example, preferably 0.1 μm or greater and 5.0 μm or less and more preferably 0.2 μm or greater and 2.0 μm or less.

### Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

Examples of the polymer charge transport material include known chemical substances having charge transport properties, such as poly-N-vinylcarbazole and polysilane. For example, a polyester-based polymer charge transport material is preferable. The polymer charge transport material may be used alone or in combination with a binder resin.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin containing a group derived from any of these substances. Specific examples thereof include compounds respectively described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of the charge mobility, for example, it is preferable that the charge transport material contains at least one selected from the group consisting of a compound (C1) represented by Formula (C1), a compound (C2) represented by Formula (C2), a compound (C3) represented by Formula (C3), and a compound (C4) represented by Formula (C4).

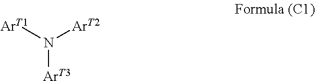

In Formula (C1), Ar^{T1}, Ar^{T2}, and Ar^{T3} each independently represent an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, an alkyl group, or an aryl group. In a case where R^{T5} and R^{T6} represent an aryl group, the aryl groups may be linked via a divalent group of —C(R⁵¹)(R⁵²)— and/or —C(R⁶¹)═C(R⁶²)—. R⁵¹, R⁵², R⁶¹, and R⁶² each independently represent a hydrogen atom or an alkyl group having 1 or more and 3 or less carbon atoms.

The group in Formula (C1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the compound (C1), for example, a compound containing at least one of an aryl group or —C₆H₄—CH═CH—CH═C(R^{T7})(R^{T8}) is preferable, and a compound (C′1) represented by Formula (C′1) is more preferable.

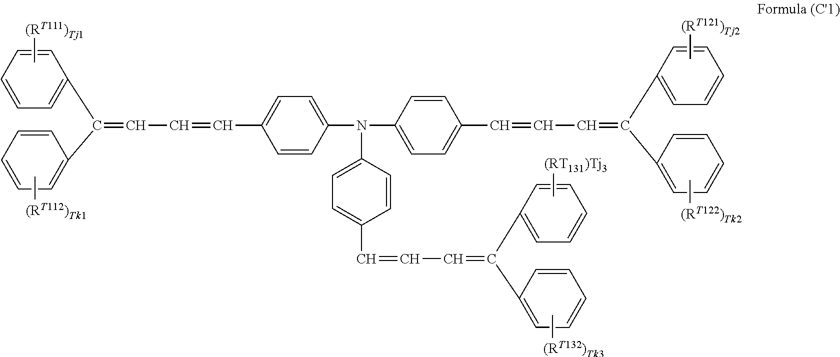

In Formula (C′1), R^{T111}, R^{T112}, R^{T121}, R^{T122}, R^{T131}, and R^{T132} each independently represent a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 each independently represent 0, 1, or 2.

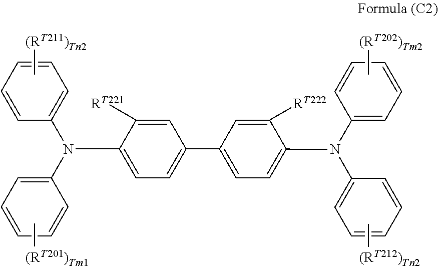

In Formula (C2), R^{T201}, R^{T202}, R^{T211}, and R^{T212} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} each independently represent a hydrogen atom, an alkyl group, or an aryl group. R^{T221} and R^{T222} each independently represent a hydrogen atom, a halogen atom, an alkyl group having 1 or more and 5 or less carbon atoms, or an alkoxy group having 1 or more and 5 or less carbon atoms. Tm1, Tm2, Tn1, and Tn2 each independently represent 0, 1, or 2.

The group in Formula (C2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the compound (C2), for example, a compound containing at least one of an alkyl group, an aryl group, or —CH═CH—CH═C(R^{T24})(R^{T25}) is preferable, and a compound containing two of an alkyl group, an aryl group, or —CH—CH—CH—C(R^{T24})(R^{T25}) is more preferable.

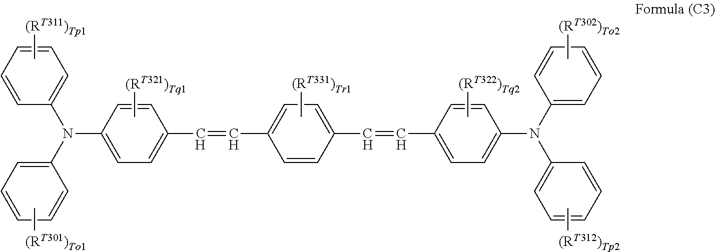

In Formula (C3), R^{T301}, R^{T302}, R^{T311}, and R^{T312} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}). R^{T31}, R^{T32}, R^{T33}, R^{T34}, and R^{T35} each independently represent a hydrogen atom, an alkyl group, or an aryl group. R^{T321}, R^{T322}, and R^{T331} each independently represent a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 each independently represent 0, 1, or 2.

The group in Formula (C3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

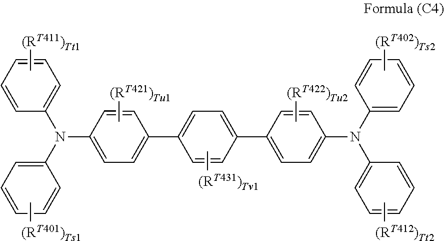

In Formula (C4), R^{T401}, R^{T402}, R^{T411}, and R^{T412} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}, R^{T44}, and R^{T45} each independently represent a hydrogen atom, an alkyl group, or an aryl group. R^{T421}, R^{T422}, and R^{T431} each independently represent a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 each independently represent 0, 1, or 2.

The group in Formula (C4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The content of the charge transport material contained in the charge transport layer is, for example, preferably 20% by mass or greater and 70% by mass or less with respect to the total mass of the charge transport layer.

The charge transport layer contains at least the polyester resin (1) as a binder resin.

The proportion of the polyester resin (1) in the total amount of the binder resin contained in the charge transport layer is, for example, preferably 40% by mass or greater, more preferably 50% by mass or greater, still more preferably 60% by mass or greater, and particularly preferably 70% by mass or greater.

In a case where the polyester resin (1) is used in combination with other resins, preferred examples of other resins used in combination include a polycarbonate resin.

According to an example of the exemplary embodiment, the charge transport layer contains the polyester resin (1) and a polycarbonate resin as the binder resin. In this case, the mass ratio between both resins (polyester resin (1):polycarbonate resin) is, for example, preferably in a range of 95:5 to 30:70 and more preferably in a range of 95:5 to 40:60.

The total mass proportion of the polyester resin (1) and the polycarbonate resin in the charge transport layer is, for example, preferably 15% by mass or greater and 80% by mass or less, more preferably 20% by mass or greater and 75% by mass or less, and still more preferably 25% by mass or greater and 70% by mass or less.

As the polycarbonate resin, for example, a polycarbonate resin with continuous constitutional units having an aromatic ring is preferable, and specific examples thereof include polycarbonate resins used in examples described below.

The charge transport layer may contain other binder resins in addition to the polyester resin (1) and the polycarbonate resin. Examples of other binder resins include a polyester resin other than the polyester resin (1), a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. These binder resins may be used alone or in combination of two or more kinds thereof.

The charge transport layer may also contain other known additives. Examples of the additives include an antioxidant, a leveling agent, an antifoaming agent, a filler, and a viscosity adjuster.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

From the viewpoints of the photosensitivity and abrasion life of the photoreceptor, the average thickness of the charge transport layer is, for example, preferably 20 μm or greater, more preferably 22 μm or greater, and still more preferably 25 μm or greater.

From the viewpoint of the residual potential, the average thickness of the charge transport layer is, for example, preferably 50 μm or less, more preferably 47 μm or less, and still more preferably 45 μm or less.

### Single Layer Type Photosensitive Layer

The single layer type photosensitive layer (charge generation/charge transport layer) is a layer containing a charge generation material, a charge transport material, a binder resin, and as necessary, other additives. These materials are the same as the materials described in the sections of the charge generation layer and the charge transport layer.

The single layer type photosensitive layer contains at least the polyester resin (1) as a binder resin.

The proportion of the polyester resin (1) in the total amount of the binder resin contained in the single layer type photosensitive layer is, for example, preferably 60% by mass or greater, more preferably 70% by mass or greater, still more preferably 80% by mass or greater, and particularly preferably 90% by mass or greater.

In a case where the polyester resin (1) is used in combination with other resins, preferred examples of other resins used in combination include a polycarbonate resin.

According to an example of the exemplary embodiment, the single layer type photosensitive layer contains the polyester resin (1) and a polycarbonate resin as a binder resin. In this case, the mass ratio between both resins (polyester resin (1):polycarbonate resin) is, for example, preferably in a range of 95:5 to 30:70 and more preferably in a range of 95:5 to 40:60.

The total mass proportion of the polyester resin (1) and the polycarbonate resin in the single layer type photosensitive layer is, for example, preferably 15% by mass or greater and 80% by mass or less, more preferably 20% by mass or greater and 75% by mass or less, and still more preferably 25% by mass or greater and 70% by mass or less.

As the polycarbonate resin, for example, a polycarbonate resin with continuous constitutional units having an aromatic ring is preferable, and specific examples thereof include polycarbonate resins used in examples described below.

The content of the charge generation material in the single layer type photosensitive layer may be, for example, 0.1% by mass or greater and 10% by mass or less and preferably 0.8% by mass or greater and 5% by mass or less with respect to the total solid content.

The content of the charge transport material contained in the single layer type photosensitive layer may be, for example, 40% by mass or greater and 60% by mass or less with respect to the total solid content.

The method of forming the single layer type photosensitive layer is the same as the method of forming the charge generation layer or the charge transport layer.

From the viewpoints of the photosensitivity and abrasion life of the photoreceptor, the average thickness of the single layer type photosensitive layer is, for example, preferably 20 μm or greater, more preferably 22 μm or greater, and still more preferably 25 μm or greater.

From the viewpoint of the residual potential, the average thickness of the single layer type photosensitive layer is, for example, preferably 50 μm or less, more preferably 47 μm or less, and still more preferably 45 μm or less.

### Protective Layer

A protective layer is provided on the photosensitive layer as necessary. The protective layer is provided, for example, for the purpose of preventing a chemical change in the photosensitive layer during charging and further improving the mechanical strength of the photosensitive layer.

Therefore, for example, a layer formed of a cured film (crosslinked film) may be applied to the protective layer. Examples of these layers include the layers described in the items 1) and 2) below.
1) A layer formed of a cured film of a composition containing a reactive group-containing charge transport material having a reactive group and a charge-transporting skeleton in an identical molecule (that is, a layer containing a polymer or a crosslinked body of the reactive group-containing charge transport material)
2) A layer formed of a cured film of a composition containing a non-reactive charge transport material and a reactive group-containing non-charge transport material containing a reactive group without having a charge-transporting skeleton (that is, a layer containing the non-reactive charge transport material and a polymer or crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a phenyl vinyl group, a vinyl phenyl group, an acryloyl group, a methacryloyl group, and a group containing at least one selected from derivatives thereof. Among these, from the viewpoint that the reactivity is excellent, for example, a vinyl group, a phenylvinyl group, a vinylphenyl group, an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, or a hydrazone-based compound. Among these, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming a protective layer in which the above-described components are added to a solvent is formed, and the coating film is dried and, as necessary, subjected to a curing treatment such as heating.

Examples of the solvent for preparing the coating solution for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

The coating solution for forming a protective layer may be a solvent-less coating solution.

Examples of the method of coating the photosensitive layer (such as the charge transport layer) with the coating solution for forming a protective layer include typical coating methods such as a dip coating method, a push-up coating method, a wire bar coating method, a spray coating method, a blade coating method, an air knife coating method, and a curtain coating method.

The average thickness of the protective layer is, for example, preferably 1 μm or greater and 20 μm or less and more preferably 2 μm or greater and 10 μm or less.

### Image Forming Apparatus and Process Cartridge

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing device that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a charge erasing device that erases the charges on the surface of the electrophotographic photoreceptor by applying the charge erasing light after the transfer of the toner image and before the charging; and an apparatus including an electrophotographic photoreceptor heating member for increasing the temperature of the electrophotographic photoreceptor and decreasing the relative temperature are employed.

In a case of the intermediate transfer type apparatus, the transfer device is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

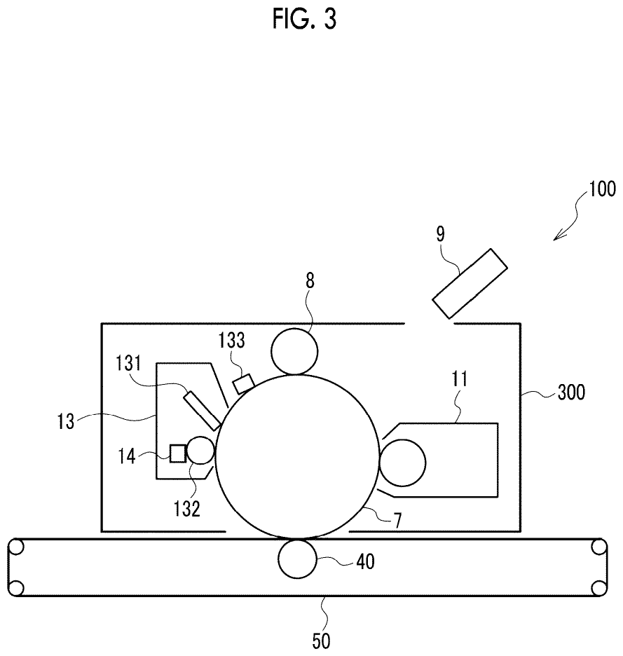

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, or a rubber blade, and a scorotron transfer charger or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

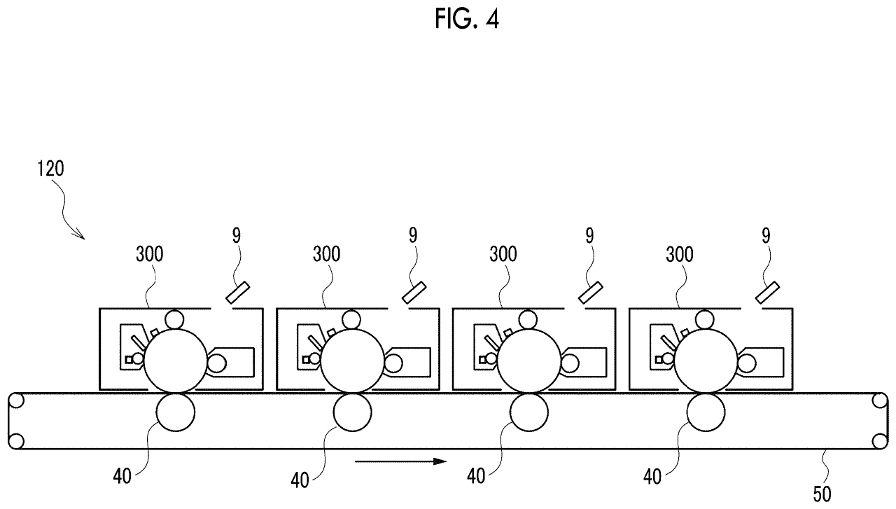

FIG. 4 is a schematic configuration view showing an example of an image forming apparatus according to the present exemplary embodiment.

An image forming apparatus 120 shown in FIG. 4 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the production, the treatment, the measurement, and the like are carried out at room temperature (25° C.±3° C.) unless otherwise specified.

### Synthesis of Polyester Resin (1)

Polyester resins (1-1) to (1-6) are synthesized. In the synthesis of all of these resins, polymerization is performed in the presence of 4-tert-butylphenol serving as a terminal-sealing agent to seal the terminals of the polyester resin.

Table 1 shows units and compositions constituting the polyester resin (1).

A2-3 and the like listed in Table 1 are specific examples of the dicarboxylic acid unit (A) described above.

B1-4 and the like listed in Table 1 are specific examples of the diol unit (B) described above.

TABLE 1

| Polyester resin (1) | Dicarboxylic acid unit (A) | | Diol unit (B) | |
|---|---|---|---|---|
| No. | No. | mol % | No. | mol % |
| (1-1) | A2-3 | 50 | B1-4 | 50 |
| (1-2) | A3-2 | 50 | B4-4 | 50 |
| (1-3) | A3-2 | 50 | B1-2 | 50 |
| (1-4) | A3-2 | 40 | B6-4 | 50 |
| | A4-3 | 10 | | |
| (1-5) | A2-3 | 50 | B1-2 | 50 |
| (1-6) | A2-3 | 50 | B2-6 | 50 |

### Production of Photoreceptor Including Lamination Type Photosensitive Layer

### Example S1

### Formation of Undercoat Layer

An aluminum cylindrical tube having an outer diameter of 30 mm, a length of 250 mm, and a thickness of 1 mm is prepared as a conductive substrate.

20 parts of a blocked isocyanate (SUMIDUR BL3175, manufactured by Sumitomo Bayer Urethane Co., Ltd., solid content of 75%) and 7.5 parts of a butyral resin (S-LEC BL-1, manufactured by Sekisui Chemical Co., Ltd., polyvinyl butyral) are dissolved in 150 parts of methyl ethyl ketone. 34 parts of a mixture of the perinone compound (1-1) and the perinone compound (2-1) (mass ratio of 50:50) is mixed with the solution and dispersed with a sand mill using glass beads having a diameter of 1 mm for 10 hours, thereby obtaining a dispersion liquid. 0.005 parts of bismuth carboxylate (K-KAT XK-640, manufactured by King Industries, Inc.) and 2 parts of silicone resin particles (TOSPEARL 145, manufactured by Momentive Performance Materials Inc.) are added to the dispersion liquid, thereby obtaining a coating solution for forming an undercoat layer. The conductive substrate is dipped in and coated with this coating solution, and the coating solution is dried and cured at 160° C. for 60 minutes, thereby forming an undercoat layer. The average thickness of the undercoat layer is as listed in Table 2.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using Cuka characteristic X-rays are at least 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads having a diameter of 1 mm. 175 parts of n-butyl acetate and 180 parts of methyl ethyl ketone are added to the dispersion liquid, and the mixture is stirred, thereby obtaining a coating solution for forming a charge generation layer. The undercoat layer is dipped in and coated with the coating solution, and the coating solution is dried at room temperature, thereby forming a charge generation layer having an average thickness of 0.18 μm.

### Formation of Charge Transport Layer

17 parts of the polyester resin (1-1) and 43 parts of a polycarbonate resin (1) as binder resins, and 40 parts by CTM-1 as a charge transport material are dissolved in 270 parts of tetrahydrofuran and 30 parts of toluene, thereby obtaining a coating solution for forming a charge transport layer. The charge generation layer is dipped in and coated with the coating solution, and the coating solution is dried at 145° C. for 30 minutes, thereby forming a charge transport layer having an average thickness of 34 μm.

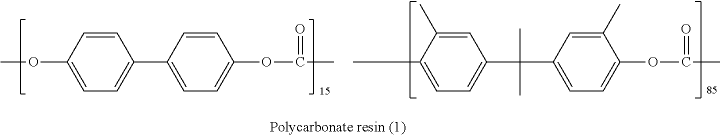

In the formulae, the numerical values denote the copolymerization molar ratios (mol %).

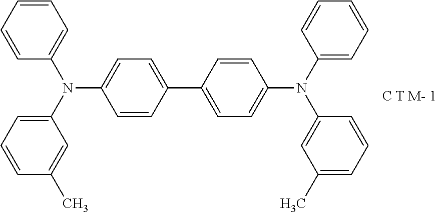 [SMILES: Cc1cccc(N(c2ccccc2)c2ccc(-c3ccc(N(c4ccccc4)c4cccc(C)c4)cc3)cc2)c1]

### Examples S2 to S23 and Comparative Examples SC1 to SC4

Each photoreceptor is prepared in the same manner as in Example S1 except that the kind and the mass ratio of the binder resin of the undercoat layer, the kind and the mass ratio of the perinone compound of the undercoat layer, the kind of the organic acid metal salt or the organic metal complex of the undercoat layer, the average thickness of the undercoat layer, the kind of the charge generation material of the charge generation layer, the kind and the mass ratio of the binder resin of the charge transport layer, the kind and the mass ratio of the charge transport material of the charge transport layer, and the average thickness of the charge transport layer are changed to the specifications listed in Tables 2 and 3.

In Example S8, the solvent of the coating solution for forming an undercoat layer is changed from methyl ethyl ketone to a mixed solvent of isopropanol and water (mass ratio 60:40).

The polyolefin (1) used in Example S8 is a resin obtained by hydrolyzing the maleic anhydride portion of BONDINE HX-8290 (Sumitomo Chemical Company, Limited, terpolymer of ethylene-acrylic acid ester-maleic anhydride) to form a triethylamine salt. Specifically, the synthesis is performed as follows.

A reaction container is charged with 75 parts of BONDINE HX-8290, 90 parts of isopropanol, triethylamine in an amount of 1.2 times equivalent to the carboxy group of the maleic anhydride in the resin, and 200 parts of distilled water, and the solution is heated at 145° C. for 60 minutes while being stirred. Next, the solution is cooled to room temperature while being stirred, and pressure-filtered through a 300-mesh stainless steel filter, thereby obtaining an aqueous dispersion of the polyolefin (1) having a solid content concentration of 20%.

In Example S9, the solvent of the coating solution for forming an undercoat layer is changed from methyl ethyl ketone to a mixed solvent of methanol and isopropanol (mass ratio of 70:30).

The polyamide (1) used in Example S9 is Amilan™ CM8000 (Toray Industries, Inc.).

“Hydroxy Ga phthalocyanine” listed in Tables 3 and 6 denotes hydroxygallium phthalocyanine.

“Ti phthalocyanine” listed in Table 3 denotes titanyl phthalocyanine.

The imide compound (A), the polyester resin (C1), and the charge transport materials CTM-2 to CTM-4 are respectively the following compounds.

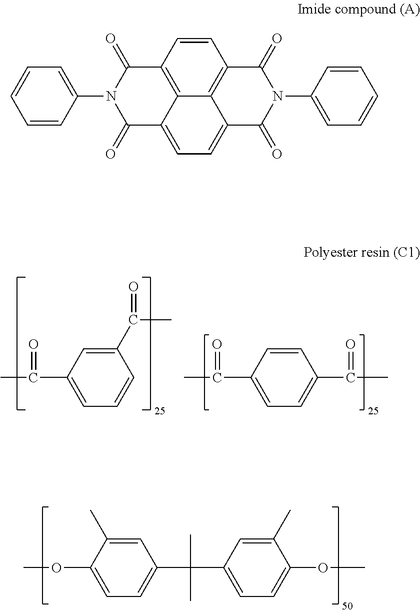

In the formulae, the numerical values denote the copolymerization molar ratios (mol %).

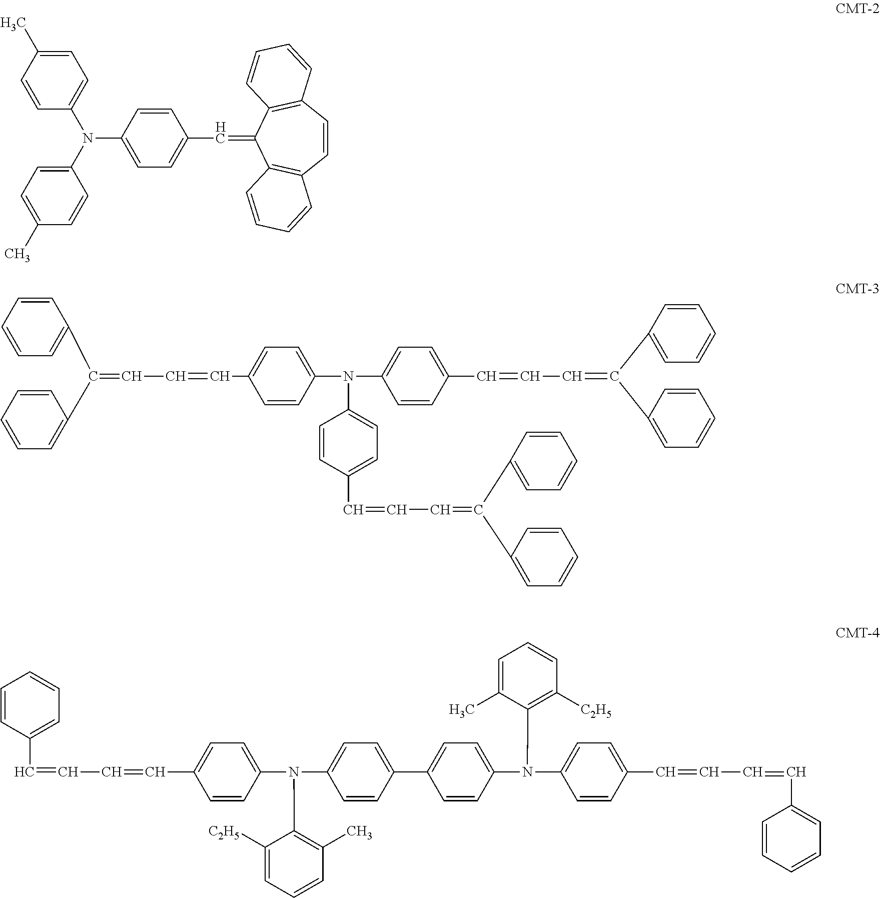

### Production of Photoreceptor Including Single Layer Type Photosensitive Layer

### Photoreceptor T1

### Formation of Undercoat Layer

An undercoat layer is formed on the conductive substrate in the same manner as in the formation of the undercoat layer in Example S1. The average thickness of the undercoat layer is as listed in Table 5.

### Formation of Single Layer Type Photosensitive Layer

52.75 parts of the polyester resin (1-1) as a binder resin, 1.25 parts of V-type hydroxygallium phthalocyanine as a charge generation material (having diffraction peaks at positions where Bragg angles (2θ±0.2°) in the X-ray diffraction spectrum using Cuka characteristic X-rays are at least 7.3°, 16.0°, 24.9°, and 28.0°), 7.8 parts of ETM-1 as an electron transport material, 38.2 parts of CTM-1 as a charge transport material (the mass ratio between ETM-1 and CTM-1 is 17:83), and 175 parts of tetrahydrofuran and 75 parts of toluene as solvents are mixed, and the mixture is subjected to a dispersion treatment in a sand mill for 4 hours using glass beads having a diameter of 1 mm, thereby obtaining a coating solution for forming a photosensitive layer. The undercoat layer is dipped in and coated with the coating solution, and the coating solution is dried and cured at a temperature of 110° C. for 40 minutes, thereby forming a single layer type photosensitive layer having an average thickness of 34 μm.

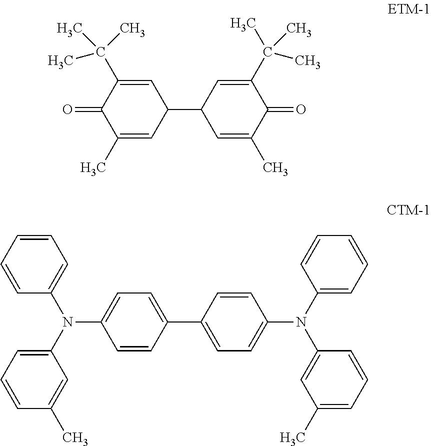 [SMILES: CC1=CC(C2C=C(C)C(=O)C(C(C)(C)C)=C2)C=C(C(C)(C)C)C1=O ; Cc1cccc(N(c2ccccc2)c2ccc(-c3ccc(N(c4ccccc4)c4cccc(C)c4)cc3)cc2)c1]

### Photoreceptors T2 to T6 and Photoreceptors TC1 to TC3

Each photoreceptor is prepared in the same manner as that for the photoreceptor T1 except that the kind of the binder resin of the undercoat layer, the kind of the perinone compound of the undercoat layer, the kind of the kind of the binder resin of the single layer type photosensitive layer, the kind of the charge transport material of the single layer type photosensitive layer, and the average thickness of the single layer type photosensitive layer are changed to the specifications listed in Tables 5 and 6.

### Performance Evaluation of Photoreceptor

Each photoreceptor of the examples or the comparative examples is mounted on an image forming apparatus Apeos C7070 (manufactured by FUJIFILM Business Innovation Corporation).

A probe connected to a surface potential meter (TREK 334, manufactured by Trek) is installed at a position which is the center of the photoreceptor and separated by 1 mm from the surface of the photoreceptor, in order to measure the surface potential of the photoreceptor.

The charging conditions and the exposure conditions are respectively adjusted such that the charging potential and the potential after exposure of the photoreceptor of Example S5 (before print evaluation) are set as the following setting A and the following setting B in an environment of a temperature of 28° C. and a relative humidity of 85%. The following print evaluation is performed on the other photoreceptors under the same charging conditions and exposure conditions.
Setting A: surface potential after charging: −700V and surface potential after exposure: −240V
Setting B: surface potential after charging: −800V and surface potential after exposure: −210V

### Maintainability of Charging Potential

70,000 sheets of full-surface halftone images with an image density of 30% are output on A3 size paper in an environment of a temperature of 28° C. and a relative humidity of 85% under conditions of the setting A and the setting B. A difference between the charging potential in a case of outputting the first sheet and the charging potential in a case of outputting the 70,000th sheet is calculated and classified as follows. The evaluation results are listed in Tables 4 and 7.
A: The difference in charging potential is less than 20 V.
B: The difference in charging potential is 20 V or greater and less than 30 V.
C: The difference in charging potential is 30 V or greater and less than 40 V.
D: The difference in charging potential is 40 V or greater and less than 50 V.
E: The difference in charging potential is 50 V or greater

### Maintainability of Potential After Exposure

70,000 sheets of full-surface halftone images with an image density of 30% are output on A3 size paper in an environment of a temperature of 28° C. and a relative humidity of 85% under conditions of the setting A and the setting B. A difference between the residual potential after the first sheet is output and exposed and the residual potential after the 70,000th sheet is output and exposed is calculated and classified as follows. The evaluation results are listed in Tables 4 and 7.
A: The difference in residual potential is less than 30 V.
B: The difference in residual potential is 30 V or greater and less than 40 V.
C: The difference in residual potential is 40 V or greater and less than 50 V.
D: The difference in residual potential is 50 V or greater and less than 60 V.
E: The difference in residual potential is 60 V or greater.

### Burn-In Ghost

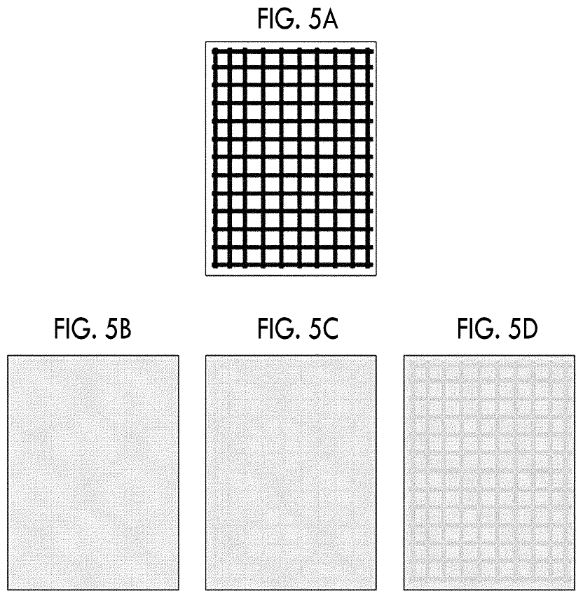

Lattice-like chart images (cyan color) shown in FIG. 5A are formed on 30,000 sheets of A3 size paper in an environment of a temperature of 28° C. at a relative humidity of 85% under the conditions of the setting A and the setting B, and one sheet of a full-surface halftone image (cyan color) with an image density of 20% is continuously output. The appearance of the lattice-like image (burn-in ghost) on the full-surface halftone image is visually observed and classified as follows. The evaluation results are listed in Tables 4 and 7.
A: As shown in FIG. 5B, a lattice-like image is not observed.
B: As shown in FIG. 5C, a lattice-like image is slightly observed.
C: As shown in FIG. 5D, a lattice-like image is clearly observed.

TABLE 2

| | Undercoat layer | | | | | | | | |
|---|---|---|---|---|---|---|---|---|---|
| | Perinone compound or imide compound | | | | | Binder resin | | Organic acid metal salt | Layer |
| | | Mixing | | Mixing | Mass | | Mass | or metal complex | thickness |
| | No. | ratio | No. | ratio | proportion | Type | proportion | Type | μm |
| Comparative | (1-1) | 50 | (2-1) | 50 | 0.58 | Polyurethane | 0.39 | Bismuth carboxylate | 7 |
| Example SC1 | | | | | | | | | |
| Comparative | (1-1) | 50 | (2-1) | 50 | 0.58 | Polyurethane | 0.39 | Bismuth carboxylate | 7 |
| Example SC2 | | | | | | | | | |
| Comparative | Imide compound | 100 | — | 0 | 0.58 | Polyurethane | 0.39 | Bismuth carboxylate | 7 |
| Example SC3 | (A) | | | | | | | | |
| Comparative | (1-1) | 50 | (2-1) | 50 | 0.58 | Polyurethane | 0.39 | Bismuth carboxylate | 7 |
| Example SC4 | | | | | | | | | |
| Example S1 | (1-1) | 50 | (2-1) | 50 | 0.58 | Polyurethane | 0.39 | Bismuth carboxylate | 7 |
| Example S2 | (1-1) | 50 | (2-1) | 50 | 0.58 | Polyurethane | 0.39 | Bismuth carboxylate | 7 |
| Example S3 | (1-1) | 50 | (2-1) | 50 | 0.58 | Polyurethane | 0.39 | Bismuth carboxylate | 7 |
| Example S4 | (1-1) | 50 | (2-1) | 50 | 0.58 | Polyurethane | 0.39 | Bismuth carboxylate | 7 |
| Example S5 | (1-1) | 50 | (2-1) | 50 | 0.58 | Polyurethane | 0.39 | Bismuth carboxylate | 7 |
| Example S6 | (1-2) | 50 | (2-2) | 50 | 0.58 | Polyurethane | 0.39 | Bismuth carboxylate | 7 |
| Example S7 | (1-1) | 50 | (2-1) | 50 | 0.58 | Polyurethane | 0.39 | Dibutyl tin dilaurate | 7 |
| Example S8 | (1-1) | 50 | (2-1) | 50 | 0.58 | Polyolefin (1) | 0.39 | — | 7 |
| Example S9 | (1-1) | 50 | (2-1) | 50 | 0.58 | Polyamide (1) | 0.39 | — | 7 |
| Example S10 | (1-1) | 50 | (2-1) | 50 | 0.45 | Polyurethane | 0.52 | Bismuth carboxylate | 7 |
| Example S11 | (1-1) | 50 | (2-1) | 50 | 0.75 | Polyurethane | 0.22 | Bismuth carboxylate | 7 |
| Example S12 | (1-1) | 50 | (2-1) | 50 | 0.35 | Polyurethane | 0.62 | Bismuth carboxylate | 7 |
| Example S13 | (1-1) | 50 | (2-1) | 50 | 0.85 | Polyurethane | 0.12 | Bismuth carboxylate | 7 |
| Example S14 | (1-1) | 50 | (2-1) | 50 | 0.58 | Polyurethane | 0.39 | Bismuth carboxylate | 12 |
| Example S15 | (1-1) | 50 | (2-1) | 50 | 0.58 | Polyurethane | 0.39 | Bismuth carboxylate | 4 |
| Example S16 | (1-1) | 50 | (2-1) | 50 | 0.58 | Polyurethane | 0.39 | Bismuth carboxylate | 33 |
| Example S17 | (1-1) | 50 | (2-1) | 50 | 0.58 | Polyurethane | 0.39 | Bismuth carboxylate | 7 |
| Example S18 | (1-1) | 50 | (2-1) | 50 | 0.58 | Polyurethane | 0.39 | Bismuth carboxylate | 7 |
| Example S19 | (1-1) | 50 | (2-1) | 50 | 0.58 | Polyurethane | 0.39 | Bismuth carboxylate | 7 |
| Example S20 | (1-1) | 50 | (2-1) | 50 | 0.58 | Polyurethane | 0.39 | Bismuth carboxylate | 7 |
| Example S21 | (1-1) | 50 | (2-1) | 50 | 0.58 | Polyurethane | 0.39 | Bismuth carboxylate | 7 |
| Example S22 | (1-1) | 50 | (2-1) | 50 | 0.58 | Polyurethane | 0.39 | Bismuth carboxylate | 7 |
| Example S23 | (1-1) | 50 | (2-1) | 50 | 0.58 | Polyurethanev | 0.39 | Bismuth carboxylate | 7 |

TABLE 3

| | | Charge transport layer | | | | | | |
|---|---|---|---|---|---|---|---|---|
| | Charge | | | | | | | |
| | generation layer | Polyester resin (1) | | | | | | |
| | Charge | | Dicarboxylic | | Diol unit | | Mass | |
| | generation | | acid unit (A) | mol | (B) | mol | proportion | Other resins |
| | material | No. | No. | % | No. | % | in layer | Type |
| Comparative | Hydroxy Ga | — | — | — | — | — | 0 | Polyester (C1) |
| Example | phthalocyanine | | | | | | | |
| SC1 | | | | | | | | |
| Comparative | Hydroxy Ga | — | — | — | — | — | 0 | Polycarbonate |
| Example | phthalocyanine | | | | | | | (1) |
| SC2 | | | | | | | | |
| Comparative | Hydroxy Ga | (1-1) | A2-3 | 50 | B1-4 | 50 | 0.6 | — |
| Example | phthalocyanine | | | | | | | |
| SC3 | | | | | | | | |
| Comparative | Hydroxy Ga | (1-1) | A2-3 | 50 | B1-4 | 50 | 0.14 | Polycarbonate |
| Example | phthalocyanine | | | | | | | (1) |
| SC4 | | | | | | | | |
| Example S1 | Hydroxy Ga | (1-1) | A2-3 | 50 | B1-4 | 50 | 0.17 | Polycarbonate |
| | phthalocyanine | | | | | | | (1) |
| Example S2 | Hydroxy Ga | (1-1) | A2-3 | 50 | B1-4 | 50 | 0.77 | — |
| | phthalocyanine | | | | | | | |
| Example S3 | Hydroxy Ga | (1-1) | A2-3 | 50 | B1-4 | 50 | 0.23 | Polycarbonate |
| | phthalocyanine | | | | | | | (1) |
| Example S4 | Hydroxy Ga | (1-1) | A2-3 | 50 | B1-4 | 50 | 0.74 | — |
| | phthalocyanine | | | | | | | |
| Example S5 | Hydroxy Ga | (1-1) | A2-3 | 50 | B1-4 | 50 | 0.6 | — |
| | phthalocyanine | | | | | | | |
| Example S6 | Hydroxy Ga | (1-1) | A2-3 | 50 | 81-4 | 50 | 0.6 | — |
| | phthalocyanine | | | | | | | |
| Example S7 | Hydroxy Ga | (1-1) | A2-3 | 50 | B1-4 | 50 | 0.6 | — |
| | phthalocyanine | | | | | | | |
| Example S8 | Hydroxy Ga | (1-1) | A2-3 | 50 | B1-4 | 50 | 0.6 | — |
| | phthalocyanine | | | | | | | |
| Example S9 | Hydroxy Ga | (1-1) | A2-3 | 50 | B1-4 | 50 | 0.6 | — |
| | phthalocyanine | | | | | | | |
| Example | Hydroxy Ga | (1-1) | A2-3 | 50 | B1-4 | 50 | 0.6 | — |
| S10 | phthalocyanine | | | | | | | |
| Example | Hydroxy Ga | (1-1) | A2-3 | 50 | B1-4 | 50 | 0.6 | — |
| S11 | phthalocyanine | | | | | | | |
| Example | Hydroxy Ga | (1-1) | A2-3 | 50 | B1-4 | 50 | 0.6 | — |
| S12 | phthalocyanine | | | | | | | |
| Example | Hydroxy Ga | (1-1) | A2-3 | 50 | B1-4 | 50 | 0.6 | — |
| S13 | phthalocyanine | | | | | | | |
| Example | Hydroxy Ga | (1-1) | A2-3 | 50 | 81-4 | 50 | 0.6 | — |
| S14 | phthalocyanine | | | | | | | |
| Example | Hydroxy Ga | (1-1) | A2-3 | 50 | B1-4 | 50 | 0.6 | — |
| S15 | phthalocyanine | | | | | | | |
| Example | Hydroxy Ga | (1-1) | A2-3 | 50 | B1-4 | 50 | 0.6 | — |
| S16 | phthalocyanine | | | | | | | |
| Example | Hydroxy Ga | (1-2) | A3-2 | 50 | B4-4 | 50 | 0.6 | — |
| S17 | phthalocyanine | | | | | | | |
| Example | Hydroxy Ga | (1-3) | A3-2 | 50 | B1-2 | 50 | 0.6 | — |
| S18 | phthalocyanine | | | | | | | |
| Example | Hydroxy Ga | (1-4) | A3-2 | 40 | B6-4 | 50 | 0.6 | — |
| S19 | phthalocyanine | | A4-3 | 10 | | | | |
| Example | Hydroxy Ga | (1-5) | A2-3 | 50 | B1-2 | 50 | 0.6 | — |
| S20 | phthalocyanine | | | | | | | |
| Example | Ti | (1-5) | A2-3 | 50 | B1-2 | 50 | 0.6 | — |
| S21 | phthalocyanine | | | | | | | |
| Example | Hydroxy Ga | (1-5) | A2-3 | 50 | B1-2 | 50 | 0.4 | Polycarbonate |
| S22 | phthalocyanine | | | | | | | (a) |
| Example | Hydroxy Ga | (1-6) | A2-3 | 50 | B2-6 | 50 | 0.6 | — |
| S23 | phthalocyanine | | | | | | | |

| | | Charge transport layer | | | | |
|---|---|---|---|---|---|---|
| | | | Proportion | | | |
| | Charge | | of | Charge transport | | |
| | generation layer | Other resins | polyester | material | | |
| | Charge | Mass | resin (1) in | | Mass | Layer |
| | generation | proportion | total mass | | proportion | thickness |
| | material | in layer | of resin | Type | in layer | μm |
| Comparative | Hydroxy Ga | 0.6 | 0.00% | CTM-1 | 0.4 | 34 |
| Example | phthalocyanine | | | | | |
| SC1 | | | | | | |
| Comparative | Hydroxy Ga | 0.6 | 0.00% | CTM-1 | 0.4 | 34 |
| Example | phthalocyanine | | | | | |
| SC2 | | | | | | |
| Comparative | Hydroxy Ga | 0 | 100.00% | CTM-1 | 0.4 | 34 |
| Example | phthalocyanine | | | | | |
| SC3 | | | | | | |
| Comparative | Hydroxy Ga | 0.46 | 23.30% | CTM-1 | 0.4 | 34 |
| Example | phthalocyanine | | | | | |
| SC4 | | | | | | |
| Example S1 | Hydroxy Ga | 0.43 | 28.30% | CTM-1 | 0.4 | 34 |
| | phthalocyanine | | | | | |
| Example S2 | Hydroxy Ga | 0 | 100.00% | CTM-1 | 0.4 | 34 |
| | phthalocyanine | | | | | |
| Example S3 | Hydroxy Ga | 0.37 | 38.30% | CTM-1 | 0.4 | 34 |
| | phthalocyanine | | | | | |
| Example S4 | Hydroxy Ga | 0 | 100.00% | CTM-1 | 0.4 | 34 |
| | phthalocyanine | | | | | |
| Example S5 | Hydroxy Ga | 0 | 100.00% | CTM-1 | 0.4 | 34 |
| | phthalocyanine | | | | | |
| Example S6 | Hydroxy Ga | 0 | 100.00% | CTM-1 | 0.4 | 34 |
| | phthalocyanine | | | | | |
| Example S7 | Hydroxy Ga | 0 | 100.00% | CTM-1 | 0.4 | 34 |
| | phthalocyanine | | | | | |
| Example S8 | Hydroxy Ga | 0 | 100.00% | CTM-1 | 0.4 | 34 |
| | phthalocyanine | | | | | |
| Example S9 | Hydroxy Ga | 0 | 100.00% | CTM-1 | 0.4 | 34 |
| | phthalocyanine | | | | | |
| Example | Hydroxy Ga | 0 | 100.00% | CTM-1 | 0.4 | 34 |
| S10 | phthalocyanine | | | | | |
| Example | Hydroxy Ga | 0 | 100.00% | CTM-1 | 0.4 | 34 |
| S11 | phthalocyanine | | | | | |
| Example | Hydroxy Ga | 0 | 100.00% | CTM-1 | 0.4 | 34 |
| S12 | phthalocyanine | | | | | |
| Example | Hydroxy Ga | 0 | 100.00% | CTM-1 | 0.4 | 34 |
| S13 | phthalocyanine | | | | | |
| Example | Hydroxy Ga | 0 | 100.00% | CTM-1 | 0.4 | 34 |
| S14 | phthalocyanine | | | | | |
| Example | Hydroxy Ga | 0 | 100.00% | CTM-1 | 0.4 | 34 |
| S15 | phthalocyanine | | | | | |
| Example | Hydroxy Ga | 0 | 100.00% | CTM-1 | 0.4 | 34 |
| S16 | phthalocyanine | | | | | |
| Example | Hydroxy Ga | 0 | 100.00% | CTM-1 | 0.4 | 40 |
| S17 | phthalocyanine | | | | | |
| Example | Hydroxy Ga | 0 | 100.00% | CTM-2 | 0.4 | 40 |
| S18 | phthalocyanine | | | | | |
| Example | Hydroxy Ga | 0 | 100.00% | CTM-4 | 0.4 | 40 |
| S19 | phthalocyanine | | | | | |
| Example | Hydroxy Ga | 0 | 100.00% | CTM-1 | 0.4 | 40 |
| S20 | phthalocyanine | | | | | |
| Example | Ti | 0 | 100.00% | CTM-1 | 0.4 | 40 |
| S21 | phthalocyanine | | | | | |
| Example | Hydroxy Ga | 0.2 | 66.70% | CTM-1 | 0.4 | 40 |
| S22 | phthalocyanine | | | | | |
| Example | Hydroxy Ga | 0 | 100.00% | CTM-3 | 0.4 | 40 |
| S23 | phthalocyanine | | | | | |

TABLE 4

| | Electronic properties | | | | | |
|---|---|---|---|---|---|---|
| | Maintainability of charging | | Maintainability of potential after | | | |
| | potential | | exposure | | Burn-in ghosts | |
| | Setting A | Setting B | Setting A | Setting B | Setting A | Setting B |
| Comparative | D | D | D | D | B | C |
| Example SC1 | | | | | | |
| Comparative | C | D | C | D | B | C |
| Example SC2 | | | | | | |
| Comparative | D | E | D | E | C | C |
| Example SC3 | | | | | | |
| Comparative | B | C | B | C | B | C |
| Example SC4 | | | | | | |
| Example S1 | A | B | A | B | A | A |
| Example S2 | A | B | A | B | A | A |
| Example S3 | A | A | A | B | A | A |
| Example S4 | A | A | A | B | A | A |
| Example S5 | A | A | A | A | A | A |
| Example S6 | A | A | A | A | A | A |
| Example S7 | A | B | A | A | A | A |
| Example S8 | A | B | A | B | A | A |
| Example S9 | A | B | A | B | A | A |
| Example S10 | A | A | A | B | A | A |
| Example S11 | A | B | A | A | A | A |
| Example S12 | A | A | A | B | A | B |
| Example S13 | B | B | A | A | A | A |
| Example S14 | A | A | A | A | A | A |
| Example S15 | A | A | A | A | A | B |
| Example S16 | A | A | A | B | A | A |
| Example S17 | B | B | B | B | A | A |
| Example S18 | A | B | A | A | A | A |
| Example S19 | A | B | A | B | A | A |
| Example S20 | A | A | A | A | A | A |
| Example S21 | A | A | A | A | A | B |
| Example S22 | A | A | A | A | A | A |
| Example S23 | A | A | A | A | A | A |

TABLE 5

| | Undercoat layer | | | | | | | | |
|---|---|---|---|---|---|---|---|---|---|
| | Perinone compound or imide compound | | | | | Binder resin | | Organic acid metal salt | Layer |
| | | Mixing | | Mixing | Mass | | Mass | or metal complex | thickness |
| | No. | ratio | No. | ratio | proportion | Type | proportion | Type | μm |
| Comparative | (1-1) | 50 | (2-1) | 50 | 0.58 | Polyurethane | 0.39 | Bismuth carboxylate | 7 |
| Example TC1 | | | | | | | | | |
| Comparative | Imide compound | 100 | — | 0 | 0.58 | Polyurethane | 0.39 | Bismuth carboxylate | 7 |
| Example TC2 | (A) | | | | | | | | |
| Comparative | (1-1) | 50 | (2-1) | 50 | 0.58 | Polyurethane | 0.39 | Bismuth carboxylate | 7 |
| Example TC3 | | | | | | | | | |
| Example T1 | (1-1) | 50 | (2-1) | 50 | 0.58 | Polyurethane | 0.39 | Bismuth carboxylate | 7 |
| Example T2 | (1-1) | 50 | (2-1) | 50 | 0.58 | Polyurethane | 0.39 | Bismuth carboxylate | 7 |
| Example T3 | (1-1) | 50 | (2-1) | 50 | 0.58 | Polyurethane | 0.39 | Bismuth carboxylate | 7 |
| Example T4 | (1-1) | 50 | (2-1) | 50 | 0.58 | Polyurethane | 0.39 | Bismuth carboxylate | 7 |
| Example T5 | (1-1) | 50 | (2-1) | 50 | 0.58 | Polyurethane | 0.39 | Bismuth carboxylate | 7 |
| Example T6 | (1-1) | 50 | (2-1) | 50 | 0.58 | Polyurethane | 0.39 | | 7 |

TABLE 6

| | | Charge transport layer | | | | | | | | | | | |
|---|---|---|---|---|---|---|---|---|---|---|---|---|---|
| | | | | | | | | | | Proportion | Charge transport | | |
| | Charge generation | Polyester resin (1) | | | | | | Other resins | | of | material | | |
| | layer | | Dicarboxylic | | Diol unit | | Mass | | Mass | polyester | | Mass | Layer |
| | Charge | | acid unit (A) | | (B) | | propor- | | propor- | resin (1) in | | propor- | thick- |
| | generation | | | mol | | mol | tion in | | tion in | total mass | | tion in | ness |
| | material | No. | No | % | No. | % | layer | Type | layer | of resin | Type | layer | μm |
| Comparative | Hydroxy Ga | — | — | — | — | — | 0 | | 0.6 | 0.00% | CTM-1 | 0.4 | 34 |
| Example | phthalocyanine | | | | | | | | | | | | |
| TC1 | | | | | | | | | | | | | |
| Comparative | Hydroxy Ga | (1-1) | A2-3 | 50 | B1-4 | 50 | 0.6 | — | 0 | 100.00% | CTM-1 | 0.4 | 34 |
| Example | phthalocyanine | | | | | | | | | | | | |
| TC2 | | | | | | | | | | | | | |
| Comparative | Hydroxy Ga | (1-1) | A2-3 | 50 | B1-4 | 50 | 0.14 | | 0.46 | 23.30% | CTM-1 | 0.4 | 34 |
| Example | phthalocyanine | | | | | | | | | | | | |
| TC3 | | | | | | | | | | | | | |
| Example T1 | Hydroxy Ga | (1-1) | A2-3 | 50 | B1-4 | 50 | 0.6 | — | 0 | 100.00% | CTM-1 | 0.4 | 34 |
| | phthalocyanine | | | | | | | | | | | | |
| Example T2 | Hydroxy Ga | (1-2) | A3-2 | 50 | B4-4 | 50 | 0.6 | — | 0 | 100.00% | CTM-1 | 0.4 | 40 |
| | phthalocyanine | | | | | | | | | | | | |
| Example T3 | Hydroxy Ga | (1-3) | A3-2 | 50 | B1-2 | 50 | 0.6 | — | 0 | 100.00% | CTM-2 | 0.4 | 40 |
| | phthalocyanine | | | | | | | | | | | | |
| Example T4 | Hydroxy Ga | (1-4) | A3-2 | 40 | B6-4 | 50 | 0.6 | — | 0 | 100.00% | CTM-4 | 0.4 | 40 |
| | phthalocyanine | | | | | | | | | | | | |
| | Hydroxy Ga | | A4-3 | 10 | | | | | | | | | |
| | phthalocyanine | | | | | | | | | | | | |
| Example T5 | Hydroxy Ga | (1-5) | A2-3 | 50 | B1-2 | 50 | 0.6 | — | 0 | 100.00% | CTM-1 | 0.4 | 40 |
| | phthalocyanine | | | | | | | | | | | | |
| Example T6 | Hydroxy Ga | (1-6) | A2-3 | 50 | B2-6 | 50 | 0.6 | — | 0 | 100.00% | CTM-3 | 0.4 | 40 |
| | phthalocyanine | | | | | | | | | | | | |

TABLE 7

| | Electronic properties | | | | | |
|---|---|---|---|---|---|---|
| | Maintainability of charging | | Maintainability of potential after | | | |
| | potential | | exposure | | Burn-in ghosts | |
| | Setting A | Setting B | Setting A | Setting B | Setting A | Setting B |
| Comparative | D | D | D | D | B | C |
| Example TC1 | | | | | | |
| Comparative | D | E | D | E | C | C |
| Example TC2 | | | | | | |
| Comparative | B | C | B | C | B | C |
| Example TC3 | | | | | | |
| Example T1 | A | A | A | A | A | A |
| Example T2 | B | B | B | B | A | A |
| Example T3 | A | B | A | A | A | A |
| Example T4 | A | B | A | B | A | A |
| Example T5 | A | A | A | A | A | A |
| Example T6 | A | A | A | A | A | A |

The electrophotographic photoreceptor, the process cartridge, and the image forming apparatus of the present disclosure include the following aspects. Each formula is the same as the formula having the same number described below.

(((1)))

An electrophotographic photoreceptor comprising:
a conductive substrate;
an undercoat layer disposed on the conductive substrate; and
a photosensitive layer disposed on the undercoat layer,
wherein the undercoat layer contains a binder resin and at least one perinone compound selected from the group consisting of a compound represented by Formula (1) and a compound represented by Formula (2),
the photosensitive layer contains a polyester resin (1) having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B), and a mass proportion of the polyester resin (1) in the photosensitive layer is 15% by mass or greater.

(((2)))

The electrophotographic photoreceptor according to (((1))),
wherein a mass proportion of the perinone compound in the undercoat layer is 30% by mass or greater and 90% by mass or less.

(((3)))

The electrophotographic photoreceptor according to (((1))) or (((2))),
wherein the undercoat layer contains polyurethane.

(((4)))

The electrophotographic photoreceptor according to any one of (((1))) to (((3))),
wherein the undercoat layer has an average thickness of 5 μm or greater and 30 μm or less.

(((5))

The electrophotographic photoreceptor according to any one of (((1))) to (((4))),
wherein the photosensitive layer further contains a polycarbonate resin.

(((6)))

The electrophotographic photoreceptor according to any one of (((1))) to (((5)
wherein the polyester resin (1) has the diol unit (B) including at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

(((7)))

The electrophotographic photoreceptor according to any one of (((1))) to (6)
wherein the photosensitive layer contains gallium phthalocyanine as a charge generation material.

(((8)))

A process cartridge comprising:
the electrophotographic photoreceptor according to any one of (((1))) to (((7))),
wherein the process cartridge is attachable to and detachable from an image forming apparatus.

(((9)))

An image forming apparatus comprising:
the electrophotographic photoreceptor according to any one of (((1))) to (((7)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer disposed on the conductive substrate; and
a photosensitive layer disposed on the undercoat layer,
wherein the undercoat layer contains a binder resin and at least one perinone compound selected from the group consisting of a compound represented by Formula (1) and a compound represented by Formula (2),
the photosensitive layer contains a polyester resin (1) having at least one dicarboxylic acid unit (A) selected from the group consisting of a dicarboxylic acid unit (A2) represented by Formula (A2), a dicarboxylic acid unit (A3) represented by Formula (A3), and a dicarboxylic acid unit (A4) represented by Formula (A4), and a diol unit (B) represented by Formula (B), and a mass proportion of the polyester resin (1) in the photosensitive layer is 15% by mass or greater, 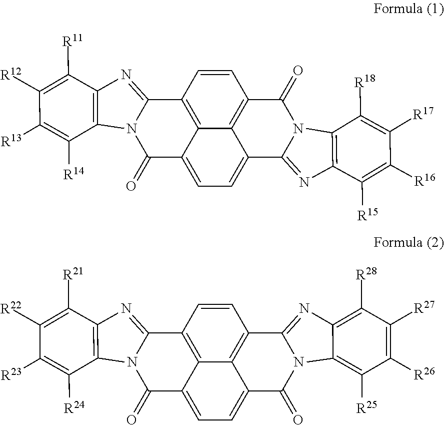
in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, and R¹³ and R¹⁴ may be each independently linked to each other to form a ring, and R¹⁵ and R¹⁶, R¹⁶ and R¹⁷, and R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, and R²³ and R²⁴ may be each independently linked to each other to form a ring, and R²⁵ and R²⁶, R²⁶ and R²⁷, and R²⁷ and R²⁸ may be each independently linked to each other to form a ring, 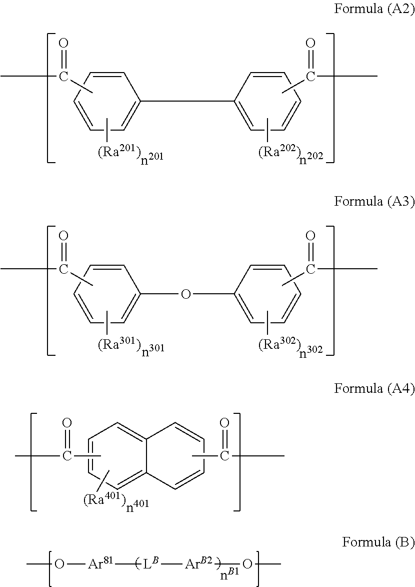
in Formula (A2), n²⁰¹ and n²⁰² each independently represent an integer of 0 or greater and 4 or less, and n²⁰¹ pieces of Ra²⁰¹'s and n²⁰² pieces of Ra²⁰²'s each independently represent an alkyl group having 1 or more and 10 or less carbon atoms, an aryl group having 6 or more and 12 or less carbon atoms, or an alkoxy group having 1 or more and 6 or less carbon atoms,
in Formula (A3), n³⁰¹ and n³⁰² each independently represent an integer of 0 or greater and 4 or less, and n³⁰¹ pieces of Ra³⁰¹'s and n³⁰² pieces of Ra³⁰²'s each independently represent an alkyl group having 1 or more and 10 or less carbon atoms, an aryl group having 6 or more and 12 or less carbon atoms, or an alkoxy group having 1 or more and 6 or less carbon atoms,
in Formula (A4), n⁴⁰¹ represents an integer of 0 or greater and 6 or less, and n⁴⁰¹ pieces of Ra⁴⁰¹'s each independently represent an alkyl group having 1 or more and 10 or less carbon atoms, an aryl group having 6 or more and 12 or less carbon atoms, or an alkoxy group having 1 or more and 6 or less carbon atoms,
in Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2, Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

2. The electrophotographic photoreceptor according to claim 1,
wherein a mass proportion of the perinone compound in the undercoat layer is 30% by mass or greater and 90% by mass or less.

3. The electrophotographic photoreceptor according to claim 1,
wherein the undercoat layer contains polyurethane.

4. The electrophotographic photoreceptor according to claim 1,
wherein the undercoat layer has an average thickness of 5 μm or greater and 30 μm or less.

5. The electrophotographic photoreceptor according to claim 1,
wherein the photosensitive layer further contains a polycarbonate resin.

6. The electrophotographic photoreceptor according to claim 1,
wherein the polyester resin (1) has the diol unit (B) including at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8), 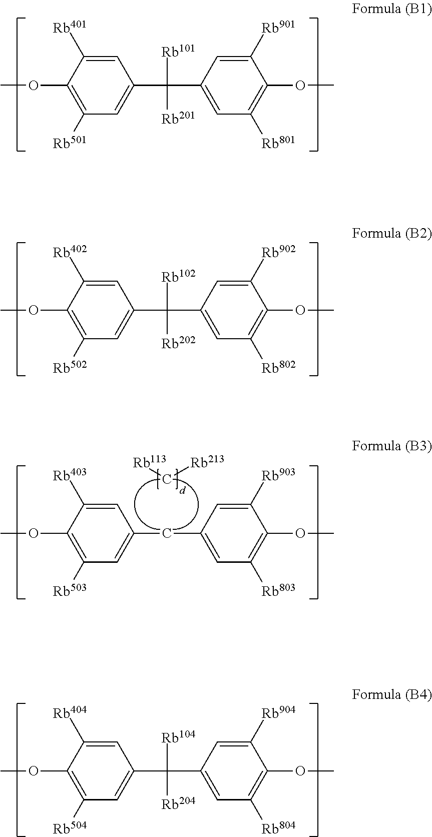 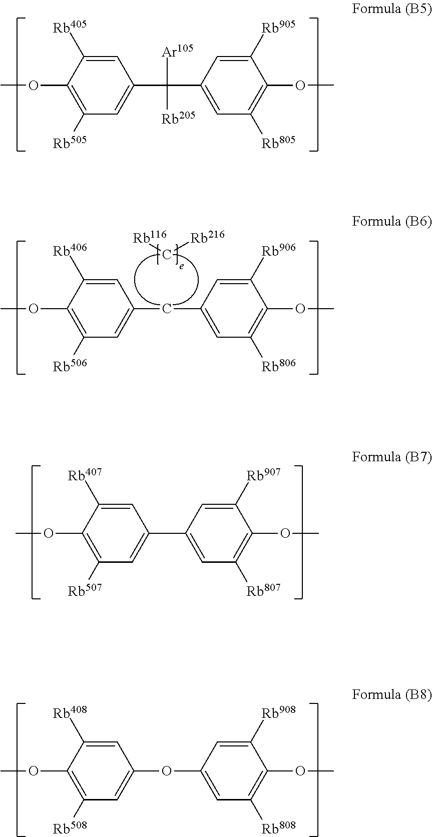
in Formula (B1), Rb¹⁰¹ represents a branched alkyl group having 4 or more and 20 or less carbon atoms, Rb²⁰¹ represents a hydrogen atom or an alkyl group having 1 or more and 3 or less carbon atoms, and Rb⁴⁰¹, Rb⁵⁰¹, Rb⁸⁰¹, and Rb⁹⁰¹ each independently represent a hydrogen atom, an alkyl group having 1 or more and 4 or less carbon atoms, an alkoxy group having 1 or more and 6 or less carbon atoms, or a halogen atom,
in Formula (B2), Rb¹⁰² represents a linear alkyl group having 4 or more and 20 or less carbon atoms, Rb²⁰² represents a hydrogen atom or an alkyl group having 1 or more and 3 or less carbon atoms, and Rb⁴⁰², Rb⁵⁰², Rb⁸⁰², and Rb⁹⁰² each independently represent a hydrogen atom, an alkyl group having 1 or more and 4 or less carbon atoms, an alkoxy group having 1 or more and 6 or less carbon atoms, or a halogen atom,
in Formula (B3), Rb¹¹³ and Rb²¹³ each independently represent a hydrogen atom, a linear alkyl group having 1 or more and 3 or less carbon atoms, an alkoxy group having 1 or more and 4 or less carbon atoms, or a halogen atom, d represents an integer of 7 or greater and 15 or less, and Rb⁴⁰³, Rb⁵⁰³, Rb⁸⁰³, and Rb⁹⁰³ each independently represent a hydrogen atom, an alkyl group having 1 or more and 4 or less carbon atoms, an alkoxy group having 1 or more and 6 or less carbon atoms, or a halogen atom,
in Formula (B4), Rb¹⁰⁴ and Rb²⁰⁴ each independently represent a hydrogen atom, an alkyl group having 1 or more and 3 or less carbon atoms, and Rb⁴⁰⁴, Rb⁵⁰⁴, Rb⁸⁰⁴, and Rb⁹⁰⁴ each independently represent a hydrogen atom, an alkyl group having 1 or more and 4 or less carbon atoms, an alkoxy group having 1 or more and 6 or less carbon atoms, or a halogen atom,
in Formula (B5), Ar¹⁰⁵ represents an aryl group having 6 or more and 12 or less carbon atoms or an aralkyl group having 7 or more and 20 or less carbon atoms, Rb²⁰⁵ represents a hydrogen atom or an alkyl group having 1 or more and 3 or less carbon atoms, and Rb⁴⁰⁵, Rb⁵⁰⁵, Rb⁸⁰⁵, and Rb⁹⁰⁵ each independently represent a hydrogen atom, an alkyl group having 1 or more and 4 or less carbon atoms, an alkoxy group having 1 or more and 6 or less carbon atoms, or a halogen atom,
in Formula (B6), Rb¹¹⁶ and Rb²¹⁶ each independently represent a hydrogen atom, a linear alkyl group having 1 or more and 3 or less carbon atoms, an alkoxy group having 1 or more and 4 or less carbon atoms, or a halogen atom, e represents an integer of 4 or greater and 6 or less, and Rb⁴⁰⁶, Rb⁵⁰⁶, Rb⁸⁰⁶, and Rb⁹⁰⁶ each independently represent a hydrogen atom, an alkyl group having 1 or more and 4 or less carbon atoms, an alkoxy group having 1 or more and 6 or less carbon atoms, or a halogen atom,
in Formula (B7), Rb⁴⁰⁷, Rb⁵⁰⁷, Rb⁸⁰⁷, and Rb⁹⁰⁷ each independently represent a hydrogen atom, an alkyl group having 1 or more and 4 or less carbon atoms, an alkoxy group having 1 or more and 6 or less carbon atoms, or a halogen atom,
in Formula (B8), Rb⁴⁰⁸, Rb⁵⁰⁸, Rb⁸⁰⁸, and Rb⁹⁰⁸ each independently represent a hydrogen atom, an alkyl group having 1 or more and 4 or less carbon atoms, an alkoxy group having 1 or more and 6 or less carbon atoms, or a halogen atom.

7. The electrophotographic photoreceptor according to claim 1,
wherein the photosensitive layer contains gallium phthalocyanine as a charge generation material.

8. A process cartridge comprising:
the electrophotographic photoreceptor according to claim 1,
wherein the process cartridge is attachable to and detachable from an image forming apparatus.

9. A process cartridge comprising:
the electrophotographic photoreceptor according to claim 2,
wherein the process cartridge is attachable to and detachable from an image forming apparatus.

10. A process cartridge comprising:
the electrophotographic photoreceptor according to claim 3,
wherein the process cartridge is attachable to and detachable from an image forming apparatus.

11. A process cartridge comprising:
the electrophotographic photoreceptor according to claim 4,
wherein the process cartridge is attachable to and detachable from an image forming apparatus.

12. A process cartridge comprising:
the electrophotographic photoreceptor according to claim 5,
wherein the process cartridge is attachable to and detachable from an image forming apparatus.

13. A process cartridge comprising:
the electrophotographic photoreceptor according to claim 6,
wherein the process cartridge is attachable to and detachable from an image forming apparatus.

14. A process cartridge comprising:
the electrophotographic photoreceptor according to claim 7,
wherein the process cartridge is attachable to and detachable from an image forming apparatus.

15. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

16. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

17. An image forming apparatus comprising:
the electrophotographic photoreceptor according to claim 3;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor according to claim 4;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. An image forming apparatus comprising:
the electrophotographic photoreceptor according to claim 5;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. An image forming apparatus comprising:
the electrophotographic photoreceptor according to claim 6;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
